(19) United States
(12) Patent Application Publication
(10) Pub. No.: US 2025/0132801 A1
(43) Pub. Date: Apr. 24, 2025

(54) METHOD FOR ENABLING GENERAL SENSING APPLICATIONS WITH COMPRESSED BEAMFORMING REPORTS

(71) Applicants: The Chinese University of Hong Kong, Hong Kong (CN); City University of Hong Kong, Hong Kong (CN)

(72) Inventors: Guoliang XING, Hong Kong (CN); Chenhao WU, Hong Kong (CN); Xuan HUANG, Hong Kong (CN); Jun HUANG, Hong Kong (CN)

(21) Appl. No.: 18/918,215

(22) Filed: Oct. 17, 2024

Related U.S. Application Data
(60) Provisional application No. 63/591,163, filed on Oct. 18, 2023.

(51) Int. Cl. H04B 7/06; H04L 25/02

(52) U.S. Cl. CPC H04B 7/0626; H04B 7/0617; H04L 25/0204

(57) ABSTRACT

A wireless sensing method and systems based on compressed beamforming reports (CBR) are provided. The method includes performing channel sounding and transmit (TX) beamforming; performing sniffing or extracting information from Wi-Fi traffic; and performing multi-path estimation. The performing multi-path estimation includes performing multi-path modeling with CBR to analyze relationship between signal propagation characteristics and information in CBR by modeling a multi-path channel based on uplink and downlink steering matrices. The performing multi-path modeling with CBR includes performing multi-path modeling with CBR from physical paths to channel state information (CSI) and subsequently from CSI to CBR. The performing multi-path estimation further includes performing maximum likelihood multi-path estimation. The performing maximum likelihood multi-path estimation includes analyzing multi-path fingerprint in CBR, performing fingerprint matching, and performing maximum-likelihood estimation (MLE)-based multi-path reconstruction.

### CROSS-REFERENCE TO RELATED APPLICATION

This application claims the benefit of U.S. Provisional Application Ser. No. 63/591,163, filed Oct. 18, 2023, which is hereby incorporated by reference in its entirety including any tables, figures, or drawings.

### BACKGROUND OF THE INVENTION

### 1 Introduction

In recent years, substantial research endeavors have been dedicated to the advancement of Wi-Fi sensing systems [43, 54]. These systems leverage the capabilities of Wi-Fi signals with the goal of enabling ubiquitous sensing across a diverse spectrum of applications, including but not limited to indoor positioning [28, 53], human activity recognition [33, 58], and identification [51, 57]. However, to learn channel properties, current Wi-Fi sensing systems have heavily relied on the channel state information (CSI), which presents a major barrier to their wide deployment on existing Wi-Fi infrastructures and off-the-shelf devices. Specifically, since 802.11 standards do not require the PHY layer to report CSI [32], CSI extraction is thus highly dependent on specific Wi-Fi chipsets and firmware support. Due to the proprietary design of Wi-Fi chips, the availability of CSI support on commodity Wi-Fi Network Interface Cards (NICs) has, until recently, remained largely elusive, with only a small number of chip families offering such support [19, 20, 52]. In particular, the large-scale measurements conducted on 38,529 operational Wi-Fi devices show that only 6% of Wi-Fi devices may support CSI extraction, demonstrating a significant gap between the vision of ubiquitous Wi-Fi sensing and the lack of CSI support on the majority of the existing Wi-Fi devices.

In order to mitigate the reliance of Wi-Fi sensing on CSI, recent research endeavors have introduced the concept of leveraging Compressed Beamforming Reports (CBR), a management frame standardized under the 802.11 protocol. CBR frames serve as carriers of essential channel information crucial for executing beamforming operations. In contrast to the traditional CSI, CBR frames can be conveniently acquired through passive monitoring of Wi-Fi traffic. However, due to the need for minimizing additional communication overhead, CBR frames are designed to convey only partial and compressed representations of the channel state, thus presenting significant challenges for effective sensing. Although there have been various initiatives to develop CBR-based sensing systems, these approaches typically either directly attempt to estimate channel characteristics or resort to machine learning (ML) models to map CBR for detecting specific events [22, 24, 34, 35]. Unfortunately, these methodological choices give rise to inherent limitations that manifest as significant reductions in accuracy and, in many cases, require impractical levels of training overhead in a variety of advanced sensing applications.

### 2 Related Work

### CSI-Based Wi-Fi Sensing

The wireless sensing systems based on radio measurements from widely deployed commodity Wi-Fi devices have been extensively studied. Early research leverages the Received Signal Strength Indicator (RSSI) as a feature of power to achieve simple fingerprinting in indoor localization [11, 55]. However, due to the fickle and coarse-grained nature, RSSI suffers from severe performance degradation in complex settings [54]. Some commercial devices provide the software interface to obtain high-resolution CSI measurements. As a result, the last decade has witnessed numerous works to leverage CSI measurements for various sensing tasks, including indoor localization [28, 36, 45, 47, 53], human activity recognition [10, 18, 37, 49, 56, 58] and authentication/identification [51, 57]. However, CSI is not widely available among deployed commodity Wi-Fi devices, which severely limits the ubiquity of CSI-based Wi-Fi sensing applications in real-world settings. Due to the increasing interest in WLAN sensing, an 802.11 task group [16] is currently standardizing the CSI extraction capability in future premium Wi-Fi devices. Nevertheless, enabling CSI extraction in accordance with the new standard likely requires new chip designs.

Referring to FIG. 1, a general setup of the conventional Wi-Fi sensing system is shown. At a high level, Wi-Fi sensing is configured to localize a Wi-Fi device or infer the activities of nearby objects by learning how signals propagate from a transmitter to a receiver. To this end, the existing Wi-Fi sensing systems rely on the CSI measurements which depict how the preamble of a received Wi-Fi packet is distorted by a wireless channel. Specifically, the CSI of an M_{TX}×M_{RX} MIMO system with K subcarriers is a collection of K M_{RX}×M_{TX} complex matrices denoted as [symbol] ϵ [symbol] ^{K×M}^{_{RX}}^{×M}^{_{TX}} where the element at (i, j) of the k-th matrix describes how the amplitude and phase of a signal in subcarrier k change when the signal propagates from the i-th antenna of the transmitter to the j-th antenna of the receiver. Generally, CSI is calculated in the Wi-Fi chipset for the receiver circuit to demodulate signals. Reporting CSI to the upper layer is not mandatory in the 802.11 standards.

### Limited Availability of CSI

To date, CSI has been available on only three Wi-Fi chipset families [19, 20, 52], which severely hinders the wide deployment and adoption of Wi-Fi sensing applications. Moreover, in today's Wi-Fi interface cards, the availability of CSI not only depends on chipset design but also requires significant efforts to reverse-engineer and modify chip firmware.

Since the 802.11 standards do not require the physical layer to report CSI, commodity Wi-Fi interface cards typically calculate CSI inside the chipset without providing a data path for sending CSI to the host device. To date, only three Wi-Fi chip families, ath9k, Intel5300, and nexmon, are known to have built-in CSI data paths for debugging purposes. Unfortunately, the availability of a similar data path is unknown in the majority of Wi-Fi interface cards due to the proprietary nature of the chipset design.

Even if the CSI data path is available in a Wi-Fi chip, enabling it for Wi-Fi sensing would require significant engineering efforts. For example, the existing CSI extraction tools need to first put the Wi-Fi chip into debug mode using chip-specific commands and then read CSI from specific memory addresses. Since chipset designs vary, enabling ubiquitous Wi-Fi sensing would require chip-specific reverse engineering and firmware modification, which can be prohibitively expensive.

### 3 CBR-Based Wi-Fi Sensing

In contrast to CSI, CBR is a more ubiquitous source of sensing data thanks to the growing popularity of TX beamforming support on commodity Wi-Fi devices. To perform Wi-Fi sensing without CSI, recent studies have proposed CBR-based sensing methods, which can be divided into two categories.

Direct CBR-based sensing methods attempt to detect events directly from CBR. Several recent works take advantage of the observation that periodic changes of channel state may result in specific patterns in CBR variation, allowing measurement of the frequency of recurrent events such as respiration rate [24-26]. Other works propose to localize devices by directly computing AoA and AoD based on CBR [22, 25]. However, because CBR contains only partial and compressed channel information, such a CBR-based direct sensing approach suffers significantly reduced accuracy and cannot support advanced sensing tasks such as gesture recognition.

ML-based sensing methods rely on training ML models to map CBR to a device location or a sensing event, such as human presence and count [27, 34, 35, 41, 42]. However, such sensing models are highly application-specific, leading to poor generalizability. In particular, since CBR is dependent on a complex set of channel factors, the sensing model needs to be re-designed and re-trained for each application and deployment scenario, resulting in prohibitive overhead.

### Multi-Path Estimation

Wireless channels are known to have sparse structures, where the signals that propagate through several dominant paths decide the received channel states. This characteristic is leveraged in indoor localizations [15, 36, 53], reducing signal blockages [40], eliminating channel feedbacks [12, 46], combating high mobility scenarios [29, 48], and designing intelligent reflecting interfaces [30]. In particular, estimating the multi-path parameters from channel information is an essential step in these problems. However, all existing work requires the knowledge of original CSI in complete or partial frequency domains of various wireless technologies such as Wi-Fi, Cellular, or mmWave. To date, there is no existing work conducted to estimate multi-path channels from the partial singular value decomposition results of the channel.

### BRIEF SUMMARY OF THE INVENTION

Embodiments of the subject invention pertain to a method and systems for enabling general sensing applications with compressed beamforming reports (CBR).

According to an embodiment of the subject invention, a wireless sensing method based on compressed beamforming reports (CBR) comprises performing channel sounding and transmit (TX) beamforming; performing sniffing or extracting information from Wi-Fi traffic; and performing multi-path estimation. The wireless sensing method based on compressed beamforming reports (CBR) may additionally comprise outputting results of the multi-path estimation for wireless sensing applications.

The performing channel sounding comprises evaluating a control frame Null Data Packet Announcement (NDPA) from a beamformer station (STA) and selecting another STA as the beamformee to receive subsequent Null Data Packet (NDP) frame. The NDP is a sounding packet that only includes a standalone frame preamble. The performing channel sounding further comprises performing channel state information (CSI) measurement to analyze ubiquity of CSI. The performing CSI measurement comprises extracting Wi-Fi chipset information by a public device tree and chipset specifications. The performing CSI measurement further comprises a two-step filtering process to analyze collected packet traces to exclude devices that do not meet conditions to install any existing CSI extraction tools. Moreover, the two-step filtering process comprises a first step of vendor-based filtering and a second step of radio capability-based filtering. The performing channel sounding further comprises computing beamforming parameters. The performing channel sounding further comprises generating compressed Beamforming Report for analyzing transmit (TX) beamforming support among deployed Wi-Fi devices. The generating compressed Beamforming Report comprises computing steering matrices and computing averaged SNR (ASNR). The performing channel sounding further comprises generating, by the beamformee, beamforming reports, and sending the reports back to the beamformer, upon measuring the channel state information from the NDP.

Moreover, the performing sniffing information from Wi-Fi traffic comprises sniffing ambient traffic to collect CBR frames of adjacent Wi-Fi links. The performing extracting information from Wi-Fi traffic comprises extracting CBR frames from a local Wi-Fi interface working in a promiscuous mode.

Further, the performing multi-path estimation comprises performing multi-path modeling with CBR to analyze relationship between signal propagation characteristics and information in CBR by modeling a multi-path channel based on uplink and downlink steering matrices. The performing multi-path modeling with CBR comprises performing multi-path modeling with CBR from physical paths to channel state information (CSI) and subsequently from CSI to CBR. The performing multi-path estimation further comprises performing maximum likelihood multi-path estimation. The performing maximum likelihood multi-path estimation comprises analyzing multi-path fingerprint in CBR, performing fingerprint matching, and performing maximum-likelihood estimation (MLE)-based multi-path reconstruction. The performing multi-path estimation is optimized by iterative searching. The performing multi-path estimation can be additionally optimized by seeded initialization.

### BRIEF DESCRIPTION OF THE DRAWINGS

FIG. 1 is schematic diagram of scenarios of CSI-based Wi-Fi Sensing, according to prior art.

FIGS. 2A and 2B are schematic diagrams of 802.11 Channel Sounding and Transmit Beamforming, according to an embodiment of the subject invention.

FIG. 3 is schematic diagram of overview of a BeamSense method and systems, wherein the BeamSense estimates multi-path parameters from sniffed bidirectional CBR frames and feeds the re-estimated channel states to downstream sensing applications, wherein to collect CBR for sensing, and the BeamSense can either sniff ambient traffic to collect the CBR frames of nearby Wi-Fi links or be deployed on one end of a Wi-Fi link to extract CBR frames from the local Wi-Fi interface working in the promiscuous mode, according to an embodiment of the subject invention.

FIG. 4 is schematic diagram of fingerprint match where Tₖ=\tilde{V}_{UL}^{T}Ĥₖ\tilde{V}_{DL,k}, wherein the non-diagonal terms are nullified and diagonal terms are constrained by ASNR, according to an embodiment of the subject invention.

FIGS. 5A-5B show testbed photos and hardware setup, wherein FIG. 5A shows controlled Devices and FIG. 5B shows Public Infrastructure, according to an embodiment of the subject invention.

FIGS. 6A-6E show estimation accuracy of the BeamSense with CBR captured from MT76 and RTL8814, the BeamSense with CBR generated from ath9k, and baselines with CSI captured from ath9k, wherein FIG. 6A shows CDF of (a) AoA estimation errors of the direct path; wherein FIG. 6B shows CDF of AoA estimation errors of the reflection path; wherein FIG. 6C shows CDF of AoD estimation errors of the direct path; wherein FIG. 6D shows CDF of AoD estimation errors of the reflection path; and wherein FIG. 6E shows CDF of relative range estimation errors, for estimators such as BeamSense, mD-Track, and SpotFi, according to an embodiment of the subject invention.

FIG. 7 shows specifications of tested COTS Wi-Fi Devices, wherein the first device is legacy 802.11n devices that have provided CSI extraction tools, wherein the second and third devices are commodity 802.11ac adapters designed for PC and laptops, respectively, and wherein the fourth, fifth, and sixth devices are commodity 802.11ac/ax routers where openwrt is installed for radio and link management, according to an embodiment of the subject invention.

FIG. 8 shows floorplan of indoor positioning experiments, wherein the symbol ▴ indicates the locations of AP devices for establishing sensing links, and wherein the symbol ● indicates the tested locations in device-based localization and passive tracking, according to an embodiment of the subject invention.

FIG. 9 shows end-to-end latency of the BeamSense under different RF and grid settings, according to an embodiment of the subject invention.

FIG. 10 shows distribution of matched path using mD-Track and the BeamSense according to an embodiment of the subject invention.

FIG. 11 shows direct path AoD estimation error of CBR-MUSIC and the BeamSense, according to an embodiment of the subject invention.

FIGS. 12A-12B show device Localization Accuracy, wherein FIG. 12A shows performance of the BeamSense in different testbed, and FIG. 12B shows CSI-based methods with the BeamSense CSI, according to an embodiment of the subject invention.

FIGS. 13A-13B show Passive Tracking Accuracy, wherein FIG. 13A shows performance of the BeamSense in different testbeds, and wherein FIG. 13B shows CSI-based methods with the BeamSense CSI, according to an embodiment of the subject invention.

FIG. 14 shows example of passive tracking using the BeamSense, according to an embodiment of the subject invention.

FIGS. 15A-15B show sign language recognition with CBR generated from SignFi dataset, wherein FIG. 15A shows recognition accuracy, and wherein FIG. 15B shows comparison between the original CSI and the CSI recovered by the BeamSense, where pixel colors represent the normalized RX gains of 3 antennas on the access point and the dark lines are caused by occlusions, according to an embodiment of the subject invention.

FIG. 16 shows sign language recognition in the testbed, according to an embodiment of the subject invention.

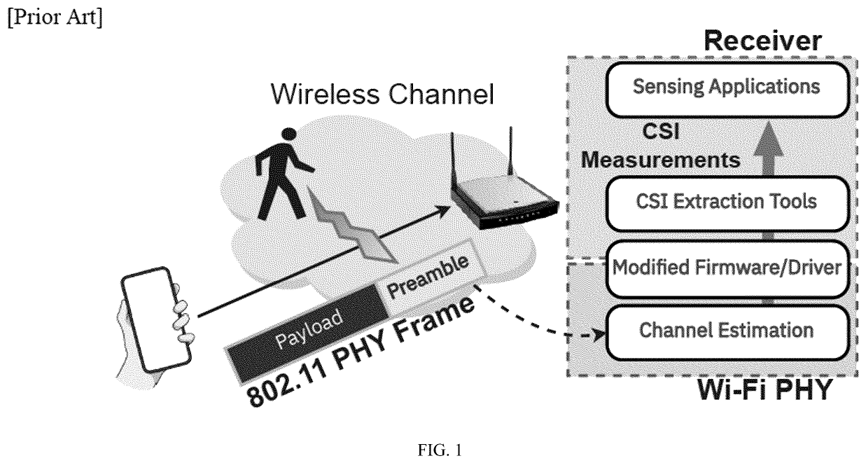

### DETAILED DISCLOSURE OF THE INVENTION

According to the embodiments of the subject invention, a wireless sensing method and systems based on compressed beamforming reports (CBR) for enabling general sensing applications are provided.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

According to embodiments of the subject invention, a Wi-Fi sensing method and systems utilize wireless signals from widely deployed Wi-Fi devices to realize sensing for a broad range of applications. The conventional Wi-Fi sensing systems heavily rely on the channel state information (CSI) to learn the signal propagation characteristics, while the availability of CSI is highly dependent on the specific Wi-Fi chipsets. Through a city-scale measurement, it is observed that the availability of CSI is extremely limited in operational Wi-Fi devices.

According to embodiments of the subject invention, a wireless sensing method and systems, called BeamSense, that exploits the compressed beamforming reports (CBR) are developed. Due to the extensive support of transmit beamforming in the operational Wi-Fi devices, CBR is commonly accessible and hence enables a ubiquitous sensing capability. The wireless sensing method and systems of the subject invention adopt multi-path estimation method that efficiently and accurately map bidirectional CBR to a multi-path channel based on intrinsic fingerprints. The wireless sensing method and systems of the subject invention can be implemented on several prevalent models of Wi-Fi devices and their performance can be evaluated by microbenchmarks and different representative Wi-Fi sensing applications. The results show that the wireless sensing method and systems of the subject invention can be configured to enable the existing CSI-based sensing models to work with CBR with high sensing accuracy and improved generalizability.

Fundamentally different from the existing CBR-based systems that are only capable of utilizing limited information of CBR, the wireless sensing method and systems of the subject invention can accurately reconstruct CSI from CBR, allowing seamless migration of a broad range of CSI-reliant sensing applications to off-the-shelf devices without compromising their performance. Therefore, the wireless sensing method and systems of the subject invention enable a ubiquitous sensing capability using the prevalent Wi-Fi infrastructures without special chipsets and firmware supports. In designing the wireless sensing method and systems of the subject invention, two key issues are overcome. First, because CBR integrates a transformed set of channel factors, the conventional multi-path models and signal processing methods cannot be readily employed to analyze CBR. Second, because deriving CBR from CSI is an irreversible transformation, recovering channel properties from CBR through the conventional methods, such as the exhaustive search for path parameters, can be prohibitively expensive. To address these issues, the key approach adopted by the subject invention is three-fold. First, the transformation from signal propagation characteristics to CBR is modelled. Then, a maximum-likelihood estimation problem is defined to determine the multi-path channel that can reproduce the CBR information. Next, to solve this problem, a computationally efficient likelihood evaluation method is devised based on the similarity between subchannel structures and then being integrated into an efficient multi-path estimation method. The approach is capable of accurately recovering the multi-path channel in real time, enabling CSI-based sensing applications to run seamlessly with CBR.

In one embodiment, the wireless sensing method and systems of the subject invention are evaluated by six commodity Wi-Fi NICs of different generations (802.11n/ac/ax) manufactured by five major vendors. Extensive experiments are conducted on three controlled testbeds and one large-scale campus Wi-Fi. The evaluation results show that the wireless sensing method and systems of the subject invention can recover multi-path properties (for example, AoA, AoD, and ToF) in real time with a high level of accuracy similar to that achieved by the conventional CSI-reliant sensing systems. Moreover, the wireless sensing method and systems of the subject invention outperform the conventional CSI-based sensing systems which are reliant on CSI tools of legacy Wi-Fi NICs with lower bandwidth and fewer antennas. The wireless sensing method and systems of the subject invention can be integrated with Wi-Fi sensing applications including, but not limited to, device localization, passive object tracking, and sign language recognition. The evaluation results show that the wireless sensing method and systems of the subject invention enable the applications to work with CBR while achieving high sensing accuracy. In particular, the wireless sensing method and systems of the subject invention can effectively depict the events of interest and significantly improve the accuracy and cross-domain generality compared to the existing learning-based methods that directly use raw CBR for sensing.

### Compressed Beamforming Report

Transmit (TX) beamforming allows the transmitter to exploit spatial diversity by steering the signals in a specific direction. To enable TX beamforming, the transmitter (beamformer) relies on channel information measured at the receiver (beamformee) to learn the steering parameters. However, exchanging full CSI can be bandwidth-consuming, especially for today's Wi-Fi systems with multiple antennas and a large number of subcarriers. The compressed beamforming report (CBR) of 802.11ac is a transformation of CSI, which comprises essential information for performing beamforming but requires significantly lower bandwidth to exchange. Mathematically, an 802.11ac CBR has two components.

Steering Matrices. For each subcarrier, the spatial signals are precoded to align with a set of the orthogonal basis of the channel matrix measured at the subcarrier. Specifically, for k-th subcarrier, the steering matrix Vₖϵ [symbol] ^{M}^{_{Bfee}}^{×M}^{_{Bfer}} is right singular vectors from Singular Value Decomposition (SVD) on Hₖϵ [symbol] ^{M}^{_{Bfee}}^{×M}^{_{Bfer}} as defined by Equation (1):

$${H}_{k} = {U}_{k} {Σ}_{k} {V}_{k}^{†} \qquad ( 1 )$$

where each column v_{k,i} is a steering vector used for adding phase shift on array elements. Herein (⋅)T, (⋅), and (⋅)† are used to denote transpose, conjugate, and conjugate transpose, respectively.

In general, the steering vectors are invariant to arbitrary phase offset, that is, ∀d∈[0, 2π]. Further, e^{j2}^{_{π}}^{d}v_{k,i} and v_{k,i} have equivalent effects in beamforming. In 802.11, this freedom is compressed with Givens Rotation, where the last row of captured steering matrix \tilde{V}k is always real. The compression is equivalent to multiplying Vk with a unitary diagonal matrix Dₖ whose diagonal elements are the column-wise phase shifts to clear the phase of the last row in Vₖ as defined by Equation (2):

$$\tilde{V} = {V}_{k} {D}_{k} \qquad ( 2 )$$

Averaged SNR (ASNR). To annotate the quality of selected beams, for each spatial subchannel, the wireless sensing system of the subject invention averages the estimated SNR over all subcarriers by Equation (3), and reports the results to the beamformer:

$$\begin{matrix}{Υ}_{i} = \frac{1}{K} {\sum }_{k}^{K} 10 {log}_{10} \frac{{P}_{TX} \cdot {λ}_{k , i}^{2}}{{P}_{N}} & i = 1 , … , {M}_{Bfer}\end{matrix} \qquad ( 3 )$$

where λ_{k,i} is the i-th singular value in the diagonal matrix Σₖ of Eq. 1, P_{TX} is the TX power and P_{N} is the measured noise power. Despite Multi-user (MU) CBR including an extra data field for per-subcarrier SNR estimation, the measurements reveal that Single-user (SU) beamforming capability is more ubiquitously supported, thus focuses are placed on the information SU CBR carries.

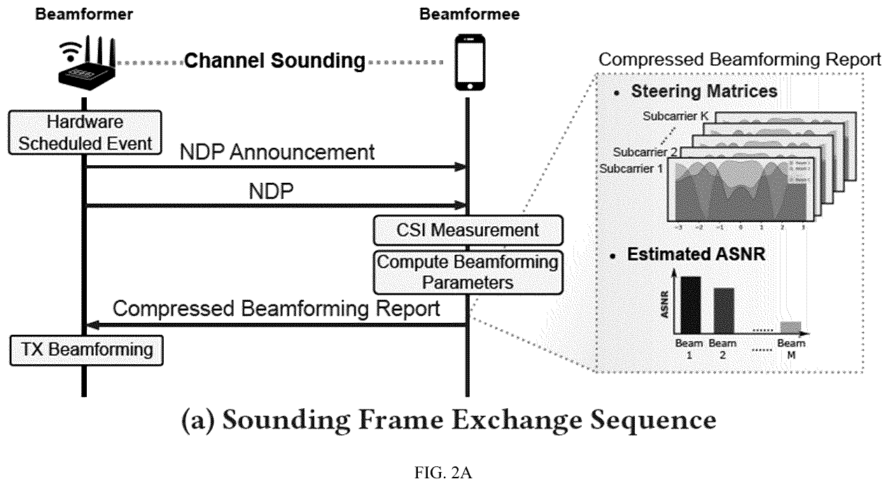

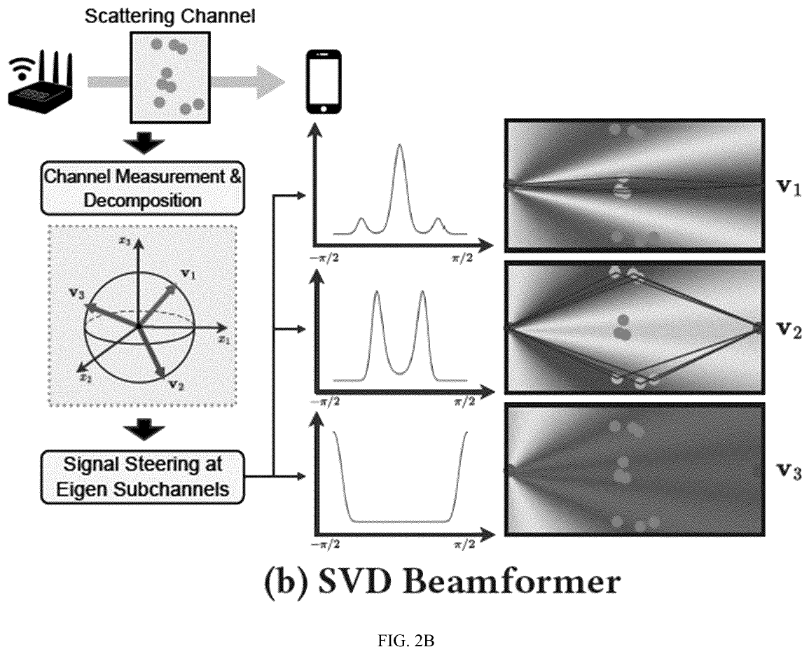

In 802.11ac, a beamformer and a beamformee exchange CBR by following a channel sounding protocol. As shown in FIG. 2A, the channel sounding protocol initiates with a control frame Null Data Packet Announcement (NDPA) from a beamformer station (STA), where another STA is selected as the beamformee to receive the subsequent NDP frame. NDP is a sounding packet, only containing a standalone frame preamble. Upon measuring the channel states from NDP, the beamformee generates beamforming reports and sends them back to the beamformer.

### 4 Generalized Wi-Fi Sensing With CBR

Contrary to CSI, CBR frames can be easily obtained via wireless traffic sniffing using commodity Wi-Fi devices, making CBR-based sensing an advantageous paradigm. The triggering of channel sounding comprises a normal control frame and an 802.11 preamble, which can be accomplished via pure layer 2 operations (for example, via packet injection and emulation) even in the absence of beamformer capability.

The key advantage of the subject invention is to enable ubiquitous Wi-Fi sensing by recovering CSI from CBR, as the multi-path information in CSI is the foundation of a diverse set of sensing systems including localization, tracking, and human activity recognition. The feature fundamentally differs from the existing CBR-based approaches, which perform sensing by directly applying machine learning or sensing algorithms on CBR, yielding poor performance and limited generalizability due to the partial and compressed channel information in CBR. By addressing these limitations, the subject invention not only achieves accurate and generalized CBR-based Wi-Fi sensing, but also allows the broad range of the existing CSI-reliant sensing systems to migrate to the already-prevalent 802.11ac-enabled devices.

### 5 Ubiquity of Wi-Fi Sensing: Measurements

In this section, measurements to understand the ubiquity of CSI (section 5.1) and the TX beamforming (TXBF) support in the current infrastructure (section 5.2) are conducted and the key results are provided in section 5.3.

### 5.1 Ubiquitous Sensing Enabled by CSI

This feature is realized by configuring the deployable rates of CSI extraction tools on commodity devices. 38,529 Wi-Fi devices (18,745 operational AP and 19,784 STA) deployed in a city are examined.

### Methodology

To examine thousands of deployed devices efficiently, the measurements are conducted by analyzing the public Wi-Fi traffic. A laptop computer is set up operating in monitor mode and walk around the city to collect Wi-Fi frames. The same route is repeated to iterate over all legitimate WLAN channels on 2.4 GHz and 5 GHz. In total, 1,360,713 frames (elapsing 610 minutes) are captured for analysis.

Examining the compliance with any CSI extraction tools of a device in the packet trace is challenging, as this capability is dependent on the product model which is not encapsulated in public 802.11 frames. To address this issue, Wi-Fi chipset knowledge provided by the public device tree and publicly available chipset specifications are utilized. The public device tree includes most of the commodity models supported by kernel drivers such as ath9k and Intel5300.

Then, a two-step filtering pipeline is designed, analyzing collected packet traces to exclude the devices that do not meet the conditions to install any existing CSI extraction tools.
Vendor-based filtering: First, all Wi-Fi devices from vendors which do not employ the three chipset families that support CSI tools are excluded. To this end, first, all vendors that should be excluded are shortlist by checking the public device tree, and then identifying all Wi-Fi devices from these vendors based on the OUI (Organization Vendor Identifier) of packet MAC addresses.
Radio capability-based filtering: Then, remaining devices are further filtered by exploiting radio capabilities for finer-grained chipset fingerprinting. The focus is placed on four capabilities, namely, max.standard, band, max.MCS, and beamforming. These capabilities of a specific Wi-Fi device can be learned based on action-specific frames such as NDPA and QoS Data, the data carried by beacon frames (if the device is an access point), and the device's response to frames modulated with specific MCS. It is worth noting that capability-based chipset fingerprinting cannot exclude all devices that do not support CSI. As a result, the estimation of CSI tools' deployable rate is optimistic.

TABLE 1
CSI and beamforming capabilities in a city-scale measurement

| | | AP | STA |
|---|---|---|---|
| CSI Tool | # Intel5300 | 0% (0) | ≤0.004% (86) |
| | # ath9k | ≤4.7% (876) | ≤1.5% (292) |
| | # nexmon | 0% (0) | ≤5.4% (1,066) |
| | Subtotal | ≤4.7% (876) | ≤7.3% (1,444) |

| | | |
|---|---|---|
| Sensing w/ CBR | 57.1% (10,712) | ≥45.5%* (3,592) |
| Total | 18,745 | 19,784 |

### Results

The upper part of Table 1 presents the optimistic deployable rate of existing CSI extraction tools. Because the radio capabilities of APs are more reliably understood (via beacon frames), the results are separated by the operation mode (that is, AP or STA) of devices. On the AP side, only shortlist 876 devices (among 18,745 OUI-Valid devices) that fall in the device tree of ath9k and align with the official specifications are shortlisted, which counts for 4.7% of the total AP devices. The STA results show a little higher deployable rate, which counts for 7.3% of all STA devices. In particular, as the chipset family supported by nexmon is adopted by several popular smartphone models (for example, Apple iPhone6 and Samsung Galaxy Series), the pipeline shortlists 1,066 devices that can possibly support nexmon. Nonetheless, the aggregate deployable rate is still lower than 6%.

### 5.2 TX Beamforming Support

As depicted in Section 4, sensing with CBR requires the devices to be able to respond with the channel sounding announcements, which is a basic component in the TX beamforming subsystem. Therefore, the ubiquity of the CBR sensing scheme can be understood by investigating the TX beamforming support among deployed Wi-Fi devices.

### Methodology

From the same dataset in section 5.1, the devices that advertised beamforming-related capabilities in their Beacon frames are crawled, as well as all the sender and receiver devices of frames used in channel sounding.

### Result

10,712 operational APs that advertise SU/MUBeamforming capabilities in their emitted beacon frames are discovered, which counts for 57.1% of the total AP devices in the packet trace. These AP devices are capable of reporting CBR when receiving channel sounding announcements from a connected device. Moreover, nearly 80% of these AP devices can perform as beamformers, implying that they can automatically provoke channel sounding to connected STA. Specifically, NDPA frames sent from 3, 215 devices among them are captured. On the other hand, among 7, 891 STA devices that have connected to APs with TX beamforming support, it is found that 45.5% (3,592) of STA devices have reported CBR frames to their APs. In total, 14, 304 deployed devices that can be used for sensing with CBR are identified.

### 5.3 Results

The implication of the measurement experiment is two-folded:
First, it is revealed that even in optimistic estimation, the conventional CSI-based sensing scheme can be deployed on lower than 6% of all Wi-Fi devices. The low penetration rate is attributed to the fact that CSI extraction capability is not required by the standards. Moreover, two of the three chipset families, ath9k and Intel5300, are 802.11n chipsets. However, among 18, 745 AP devices, only 28.7% (5, 376) devices are found to support up to 802.11n.
On the contrary, the measurement experiment characterizes a decent installation rate of TX beamforming subsystems in the existing Wi-Fi deployments. Over half of the deployed devices are capable of participating in TX beamforming and reporting CBR frames. The penetration rate is as high as 57.1% in all operational APs and, particularly, 73.2% in the devices compliant with 802.11ac or newer standards. Bidirectional CBR can be generated from these devices via layer II operations and used for sensing.

### 6 Design of BeamSense

### 6.1 Challenges

Instead of relying on CSI which is only available on a few Wi-Fi chips, the aim is to enable generalized Wi-Fi sensing with CBR which is already supported by prevalent 802.11ac-enabled devices. However, there are several challenges.

### Significant Domain Shift in CBR

As discussed in section 3, CBR is derived from the SVD factorization of CSI, and contains only partial and transformed information about signal propagation characteristics. Therefore, CBR cannot be directly used by the existing CSI-based Wi-Fi sensing methods. To address this challenge, a straightforward approach is to re-design and train ML models from the samples of CBR. However, as the SVD is a synthetic result of multiple factors of the channel, significant gaps exist between the CBRs captured with different environments, objects/activities of interest, and RF configurations. Therefore, simply using CBRs to fingerprint sensing events can be expensive in training and lacks generalizability.

### Mapping CBR to CSI

Instead of designing sensing methods directly based on CBR, recovering CSI from CBR will not only enable generalized Wi-Fi sensing but also allow seamless migrations of the existing CSI-based sensing systems to the majority of Wi-Fi chips. However, it is challenging to map CBR to the original CSI. Since SVD is known to be a one-way factorization and bidirectional CBR only depicts partial SVD results, the original CSI matrix cannot be derived with a closed-form solution or with the existing signal processing techniques.

### Computational Overhead of Multi-path Estimation

The multi-path channel model is employed to understand the interplay between the physical channel and the corresponding bidirectional CBR. Based on the model, a naive approach to obtain a multi-path channel is to apply maximum-likelihood estimation (MLE) to exhaustively search the entire solution space of multi-path parameters, compute the SVD of each solution, and compare the SVD result with bidirectional CBR. However, such a naive approach is highly complex in theory and prohibitively expensive in practice. In particular, the time complexity of SVD is proportional to the cube of the number of antennas, which further scales with the number of subcarriers. Through empirical measurements conducted on a laptop with 3.2 GHz CPU, it is determined that computing the SVD with the widely used LAPACK library takes about 0.5 ms for the CSI of a 4×4 MIMO system. Moreover, the solution space has an extraordinarily high dimension. For example, in order to search the space of 6 paths with a step of one degree AoA and AoD and of one nanosecond path delay, there will be 2¹²⁸ possible multi-path profiles to be evaluated. Combined with the non-negligible overhead in evaluating SVD, the overall computation delay is prohibitively high, which in some case can be over days.

### 6.2 Overview of BeamSense Method and Systems

To enable generalized Wi-Fi sensing without relying on special chip and firmware support, the wireless sensing method and systems of the subject invention accurately and efficiently reconstruct a multi-path channel from bidirectional CBR. The wireless sensing method and systems of the subject invention can be deployed as an underpinning layer below the existing CSI-based Wi-Fi sensing systems, enabling them to seamlessly operate on CBR and migrate to the majority of the existing Wi-Fi infrastructures and the off-the-shelf devices on which CSI is not available.

Referring to FIG. 3, an overview of the BeamSense method and systems of the subject invention is illustrated. The BeamSense estimates multi-path parameters from sniffed bidirectional CBR frames and feeds the re-estimated channel states to downstream sensing applications, wherein to collect CBR for sensing, BeamSense can either sniff ambient traffic to collect the CBR frames of nearby Wi-Fi links or be deployed on one end of a Wi-Fi link to extract CBR frames from the local Wi-Fi interface working in the promiscuous mode, according to an embodiment of the subject invention.

To reconstruct a multi-path channel from CBR, the relationship between signal propagation characteristics and the information carried by CBR is characterized, and then a computationally efficient method is employed to tackle the key challenges discussed in section 6.1. First, rather than factorizing multi-path channels to search for matched path parameters, the wireless sensing method and systems of the subject invention leverage the key observation that multi-path channels render unique subchannel structures after SVD, which can be adopted as a fingerprint to match path parameters with bidirectional CBR without actually computing SVD. With this insight, multi-path estimation is formulated based on a computationally efficient MLE. Instead of maximizing the match of SVD results, the wireless sensing system of the subject invention seeks to minimize the error of fingerprint match, which significantly reduces computational overhead. Moreover, parameter search is optimized based on iterative expectation maximization and strategic initialization points optimization, which help the wireless sensing system of the subject invention converge to an accurate estimation with a significantly reduced search overhead, enabling multi-path estimation from CBR in real time.

### 6.3 Multi-Path Modeling With CBR

The relationship between the signal propagation characteristics and the information in CBR are analyzed by modeling a multi-path channel based on uplink and downlink steering matrices. The model enables accurate and efficient multi-path estimation based on CBR, as detailed in section 6.4.

### From Physical Paths to CSI

The CSI of a multi-path channel describes how a signal changes as it propagates along multiple paths from a transmitter to a receiver. The CSI of a signal traversing a single path can be expressed by Equation (4),

$$h ( {f}_{k} , {α}_{p} , {ϕ}_{p} , {ψ}_{p} , {τ}_{p} ) = {α}_{p} {e}^{- j 2 π f τ} pF ( {ϕ}_{p} , {ψ}_{p} ) \qquad ( 4 )$$

where fₖ is the transmission frequency, αₚ is the attenuation factor, ϕₚ and ψₚ are the Angle of Arrival (AoA) and Angle of Departure (AoD), and τₚ is a delay incurred by propagation and Doppler effects. For a M_{RX}×M_{TX} MIMO system, F(ϕₚ, ψₚ)ϵ [symbol] ^{M}^{_{RX}}^{×M}^{_{TX}} is a matrix that represents how signal phases change across antennas. F(ϕ, ψ) can be expressed by Equation (5),

$$F ( ϕ , ψ ) = \vec{a} ( ϕ ) ⊗ \vec{d} ( ψ ) \qquad ( 5 )$$

Where \vec{a}(ϕ) and \vec{d}(ψ) are the array vectors of the transmitter and receiver, depending on the shape of antenna arrays. For instance, for a uniform linear array where adjacent antennas are separated by s, the array vectors are defined by Equations (6) and (7):

$$\vec{a} ( f , ϕ ) = [ 1 , {e}^{- j 2 π fssin ϕ / c} , … , {e}^{- j 2 π {fsM}_{RX} sin ϕ / c} ] \qquad ( 6 )$$

$$\vec{d} ( f , ψ ) = [ 1 , {e}^{- j 2 π fssin ψ / c} , … , {e}^{- j 2 π {fsM}_{TX} sin ψ / c} ] \qquad ( 7 )$$

A multi-path channel is the sum of single-path channels, which can be expressed as Equation (8):

$${\hat{H}}_{k} ( {\{ {\hat{α}}_{p} , {\hat{ϕ}}_{p} , {\hat{ψ}}_{p} , {\hat{τ}}_{p} \}}_{p = 1}^{P} ) = {\sum }_{p} h ( {f}_{k} , {\hat{α}}_{p} , {\hat{ϕ}}_{p} , {\hat{ψ}}_{p} , {\hat{τ}}_{p} ) \qquad ( 8 )$$

where P denotes the number of paths.

### From CSI to CBR

Next, a multi-path channel H is modeled with bidirectional CBR. Without loss of generality, the focus is placed on the downlink channel at a specific subcarrier. Since both uplink and downlink signals traverse the same physical paths, their channel matrices at the same frequency are the transpose of each other (that is, swapping index of TX-RX antennas) after normalizing the transmit power. Thus, the corresponding downlink multi-path channel H can be decomposed with either the uplink or downlink steering matrices, as shown in Equation (9):

$$H = {U}_{DL} Σ {\tilde{V}}_{DL}^{†} = {UL}_{} Σ {U}_{UL}^{T} \qquad ( 9 )$$

where \tilde{V}_{DL} and \tilde{V}_{UL} are the steering matrices decoded from downlink and uplink CBR. Since [symbol] _{UL,k} and U_{DL} are both left singular matrix of H, there is a column-wise phase shift D such that U_{DL}= [symbol] _{UL}D. To this end, the downlink channel can be expressed with bi-directional CBR by Equation (10):

$$H = {UL}_{} D Σ {\tilde{V}}_{DL}^{†} \qquad ( 10 )$$

Since the subchannel gains Σ and the coordinate rotation matrix D are unknown from CBR, the SVD of a multi-path channel cannot be directly reversed. This also inhibits the straightforward application of existing multi-path estimators and phase analysis methods for directly computing channel properties, resulting in a key barrier to perform Wi-Fi sensing using CBR.

### 6.4 Maximum Likelihood Multi-Path Estimation

Because deriving CBR from CSI is an irreversible transformation, the wireless sensing system of the subject invention estimates a multi-path channel from CBR by searching for path parameters that reproduce the bidirectional CBR. To this end, a naive approach would factorize candidate multi-path channels and examine SVD results, which is prohibitively expensive due to the cost of SVD. Moreover, because CBR is derived from transformed channel factors that are highly dependent on the deployment environment, data-driven approaches, such as leveraging ML models to infer channel properties from CBR, would result in prohibitive training overhead.

To overcome this issue, the wireless sensing system of the subject invention leverages the unique subchannel structures of CBR as a multi-path channel fingerprint and designs a multi-path estimation method. An MLE problem is defined to maximize fingerprint matching, which does not require expensive SVD and therefore significantly reduces compute overhead.

### Multi-Path Fingerprint in CBR

The key observation is that multipath channels can be fingerprinted based on the unique subchannel structures after SVD. Specifically, two subchannel structures are exploited.
(1) Null Gains of Non-Diagonal Terms: Because (DΣ) in Equation (9) is a diagonal matrix, all non-diagonal elements of \tilde{V}_{UL}^{T}H\tilde{V}_{DL} are equal to zero.
(2) Diagonal Gains Constrained by ASNR: By Equation (9), the norm of diagonal terms ∥xᵢᵢ| in \tilde{V}_{UL}^{T}H\tilde{V}_{DL} are supposed to equal the singular values of H, that is, the subchannel gains. However, the per-subcarrier channel gains are not included in CBR. Therefore, for the i-th subchannel, the i-th DL ASNR report [symbol] _{DL,i} is used to formulate the constraints of the sum Σₖ₌₁^{K}∥^{k}^{ₓᵢᵢ}∥ Specifically, the geometric mean of the i-th subchannel gains are first derived by Equation (11):

$${\overline{λ}}_{iG} = {( \prod {λ}_{k , i} )}^{1 / K} = {10}^{{Υ}_{i} / 20 \cdot \sqrt{{P}_{N} / {P}_{TX}}} \qquad ( 11 )$$

The characteristics of Wi-Fi signals that the powers across subcarriers must satisfy a low Peak-to-Average-Power ratio as required by signal demodulation [21], which implies λ̅ᵢ>>Var(λᵢ). Under this constraint, the arithmetic mean of subchannel gains λ̅i can be approximated by λ̅i_{G} [13]. Finally, the sum of diagonal gains is subject to satisfy the condition:

$${\sum }_{k = 1}^{K} ‖ {}^{k} {x}_{ii} ‖ = K {\overline{λ}}_{{i}_{G}} , ∀ i ∈ [ 1 , {M}_{TX} ] .$$

### Fingerprint Matching

Given a multi-path profile {αₚ, ϕₚ, ψₚ, τₚ} and a pair of uplink CBR [{\tilde{V}_{UL,k}}, { [symbol] _{UL,i}})] and downlink CBR [{\tilde{V}_{DL,k}}, { [symbol] _{DL,i}}], the wireless sensing system of the subject invention computes a fingerprint matching matrix T, which is expressed by Equation (12),

$$T = {\tilde{V}}_{UL}^{T} \hat{H} ( \{ {α}_{p} , {ϕ}_{p} , {ψ}_{p} , {τ}_{p} \} ) {\tilde{V}}_{DL} \qquad ( 12 )$$

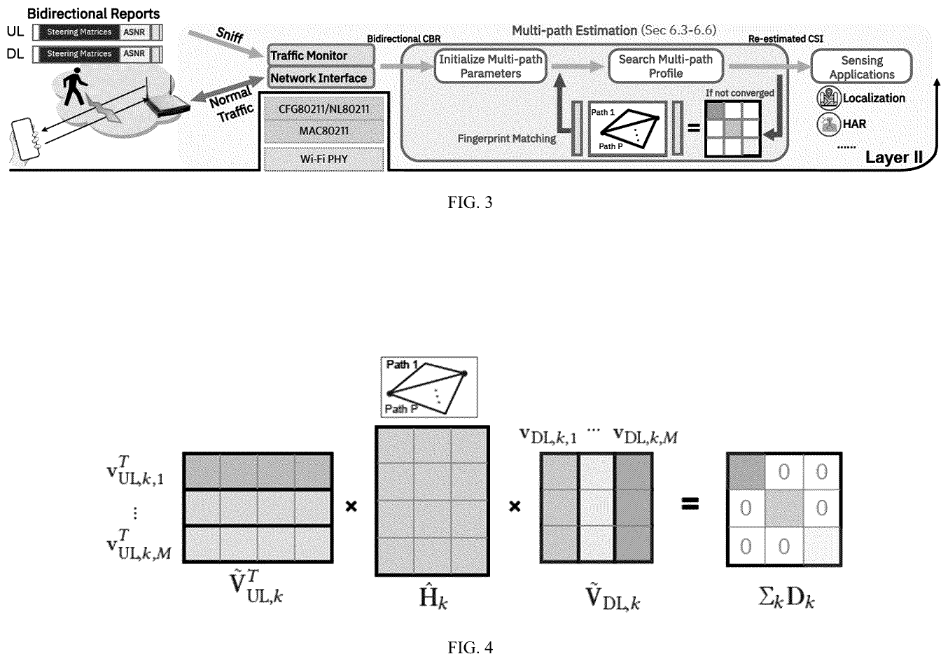

To understand why T characterizes fingerprint match, the effect of each product in the SVD factorization is considered. As shown in FIG. 2B, SVD extracts the orthogonal subchannels from the measured channel matrix, where U, Σ, V depict the output subspace, subchannel gains, and input subspace, respectively. The input subspace and the output subspace jointly describe the subchannel structures at a given subcarrier. Each input and output subspace is represented by a set of unitary biorthogonal vectors. The factorization uniquely pairs an input vector in V with an output vector in U in a way that for every paired vectors u and v, the product u^{T}·H·v is the gain of this subchannel λ, and for every unpaired vectors u^{⊥} and v, the product (u^{⊥})^{T}·H·v is null. Based on this observation, (u,v) is exploited to bypass the computation of SVD. As shown in FIG. 4, the estimated multi-path channel is matched with the actual multi-path channel, if all non-diagonal terms are zero and the mean of diagonal terms match the ASNR.

### MLE-Based Multi-Path Reconstruction

For each subcarrier, a fingerprint matching matrix Tₖ is constructed. The likelihood of a candidate multi-path profile is computed based on fingerprint match, which is characterized using a loss function as defined by Equation (13),

$${ℒ}^{★} ( ℋ ) = {\sum }_{i = 1}^{M} {\sum }_{k = 1}^{K} ( ‖ {}^{k} {t}_{ii} ‖ - \overline{{λ}_{{i}_{G}}} ) + {{\sum }_{i = 1}^{M} {\sum }_{j = 1}^{M} {\sum }_{k = 1}^{K}}_{j \neq i} ‖ {}^{k} {t}_{ij} ‖ \\ \{ {\hat{α}}_{p} , {\hat{ϕ}}_{p} , {\hat{ψ}}_{p} , {\hat{τ}}_{p} \} = {arg min}_{\{ {α}_{p} , {ϕ}_{p} , {ψ}_{p} , {τ}_{p} \} ∈ Ω} {ℒ}^{★} ( ℋ ) \qquad ( 13 )$$

where Ω is the search space of multi-path profiles.

It is noted that, although the asymptotic complexity of computing T is the same as reproducing CBR, the coefficient is much lower. Specifically, the coefficient of computing T with LAPACK is far smaller than one. In comparison, the coefficient of computing SVD can range from 8 to 20.

### 6.5 Searching Multi-Path Parameters

Multi-path channels feature a high-dimensional parameter space, which can be highly expensive to search. For example, a naïve approach to this problem is to divide the parameter space into fixed-size grids and then examine all grids, which would result in a prohibitive complexity of Ω_{α}^{p}×Ω_{ϕ}^{p}×Ω_{ψ}^{p}×ψ_{τ}^{p}. To address this problem, the wireless sensing system of the subject invention employs two optimization strategies, namely, iterative searching and seeded initialization.

Algorithm 1: BeamSense Multi-path Estimation

| | Input: {V_{DL,k}}ₖ₌₁^{K}, {V_{UL,k}}ₖ₌₁^{K}, {Υ_{DL,i}}ᵢ₌₁^{M} |
|---|---|
| | Output: {\hat{α}ₚ, \hat{ϕ}ₚ, \hat{ψ}ₚ, \hat{τ}p}ₚ₌₁^{p} |
| 1 | Initialize starting pont of {αₚ⁰, ϕₚ⁰, ψₚ⁰, τₚ⁰}ₚ₌₁^{p}; |
| 2 | ϵ: Conergence Threshold; |
| 3 | Initialize g⁰ = +∞, t = 1; |
| 4 | while converged == false do |
| 5 | \| for each path p = 1, 2, . . . , P do |
| 6 | \| \| for each path parameter η in (αₚ^{t-1}, ϕₚ^{t-1}, ψₚ^{t-1}, τₚ^{t-1}) |
| | \| \| do |
| 7 | \| \| \| ηₚ^{t} [symbol] ⁽ηₚ); |
| 8 | \| \| end |
| 9 | end |
| 10 | \|gt ← [symbol] ^{*} ({Hₖ(αₚ^{t}, ϕₚ^{t}, ψₚ^{t}, τₚ^{t}}ₚ₌₁^{p})}ₖ₌₁^{K}); |
| 11 | \|if ∥gₜ − gₜ₋₁∥ < ϵ then ϵ |
| 12 | \| \|converged = true; |
| 13 | \| \|{\hat{α}ₚ, \hat{ϕ}ₚ, \hat{ψ}ₚ, \hat{τ}ₚ}ₚ₌₁^{p} ε← {αₚ^{t}, ϕₚ^{t}, ψₚ^{t}, τₚ^{t}}ₚ₌₁^{p}; |
| 14 | \| end |
| 15 | \|t = t +1; |
| 16 | end |

### Iterative Searching

Instead of searching the parameter space based on grids, the wireless sensing system of the subject invention performs iterative expectation maximization (EM) with the coordinate descent strategy. In each iteration, the wireless sensing system of the subject invention optimizes parameters sequentially. For each parameter, an optimal value is searched while keeping all other parameters fixed. The iteration is terminated when Equation (12) converges. Although iterative searching does not assure a globally optimal solution, convergence is guaranteed due to the non-increasing objective function. In this way, the number of searched grids is reduced to

$${\sum }_{p = 1}^{P} ( {Ω}_{α} + {Ω}_{ϕ} + {Ω}_{ψ} + {Ω}_{τ} ) .$$

### Seeded Initialization

Similar to most non-convex optimization problems, the performance of iterative searching depends on the choice of initialization point. To address this issue, a strategy similar to genetic search is employed. As described in Algorithm 1 above, to initiate iterative searching, optimization is run on coarse-grained grids and the optimal N grids are picked as initialization points, where a new search is started from each point. Finally, the optimal parameters among the N searches are used to reconstruct the multi-path channel.

### 6.6 Implementation

This section presents the implementation of an embodiment of the wireless sensing system of the subject invention, BeamSense.

### Software

After the link establishments, as scheduled by the on-chip timer, two connected devices initiate channel sounding in turns, and bidirectional CBR frames show up in the wireless traffic. BeamSense is deployed on one of the devices that runs a concurrent monitor interface and Scapy library [31] is used to read the exchanged frames. Steering matrices and ASNRs are decoded from captured CBR frames in accordance with the 802.11 standards. Before multi-path estimation, the bidirectional CBR is interpolated with a modified slerp interpolator [39] to obtain a time-synchronized bidirectional report series. The report series is then passed to the multi-path estimator implemented with C++, which runs Algorithm 1 to produce estimated CSI series.

### Grid Space

In each iteration of the multi-path estimation, BeamSense finds the path parameters on a grid space that optimizes [symbol] *(Line 5-8 of Algorithm 1). The range and resolution of grid space are designed with a tradeoff between accuracy and computation efficiency. The searching range of the angular parameters are empirically set to [−π/2, π/2] rad with step size 0.03 rad, range of the delay parameters to [0, 150] ns with a step size of 1 ns, and range of attenuation parameters to [0, 1] with a step size of 1% across all the experiments.

### Eliminating Radio Chain Offsets

The captured CBR is distorted by the Radio Chain Offsets (RCO), which is caused by the disparity in the antenna chains and leads to inaccurate AoA/AoD estimations. With RCO existing at both TX and RX arrays, the channel measurement is distorted by H_{dist}=Λ_{RX}HΛ_{TX}, where Λ_{RX} and Λ_{TX} are diagonal RCO matrices and the diagonal terms denote the phase offsets between antenna elements. It is found that RCO is constant over time and frequency domain. Based on this observation, a simple cleaning scheme is provided to eliminate its effect. First, the neighboring TX chains and RX chains are connected with coaxial cables and the ideal steering matrices V_{k,ideal} by the known cable lengths are calculated. Since RCO incurs column-wise unit phase shift to Hₖ, the captured steering matrix is distorted by \tilde{V}ₖ=Λ_{Bfer}^{†}V_{k,ideal}. Then, the RCO at the beamformer's array can be estimated by Equation (14) and used to compensate for CBR captured in the same run.

$${Λ}_{Bfer} = {arg min}_{Λ ∈ {Ω}_{Λ}} {\sum }_{k = 1}^{K} {‖ {\tilde{V}}_{k} - {Λ}^{†} {V}_{k , ideal} ‖}_{2} \qquad ( 14 )$$

On the other hand, CBR is immune to 3 types of radio errors that are commonly considered in previous Wi-Fi sensing systems, i.e., sampling frequency offset, symbol timing offset, and carrier frequency offset [32]. Because at each subcarrier, these 3 types of errors cause identical phase shifts to all antenna pairs, and therefore the SVD result is invariant.

### Evaluation

This section presents the evaluation of BeamSense in two real-world testbeds. The performance of BeamSense is first examined with several microbenchmarks (section 7.2) and then the performance of three representative Wi-Fi sensing applications is evaluated with BeamSense estimated channel states (sections 7.3, 7.4, and 7.5).

### 7.1 Methodology

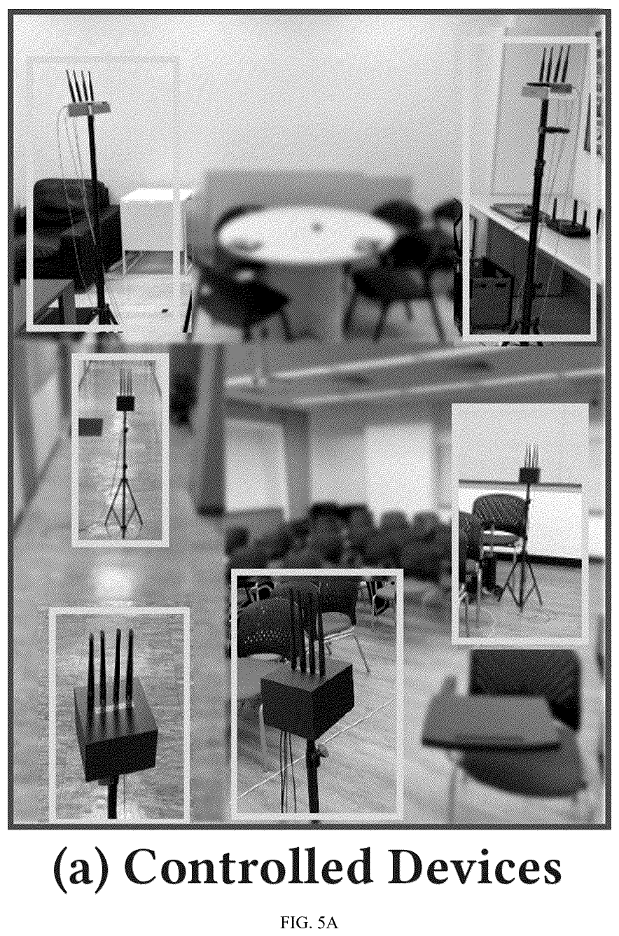

The experiments are conducted in two types of indoor testbeds as shown in FIGS. 5A and 5B, respectively:
Controlled Testbed: as shown in FIG. 5A, the majority of experiments are conducted in a controlled testbed, where controlled devices are used to set up all the sensing links. This testbed comprises three different indoor environments. The first is a small meeting room (7.2×5.4 m²) with a desk and some furniture. The second is a large lecture room (12×10 m²) with multiple rows of plastic chairs and a narrow aisle. The last one is a corridor of 1.8 m in width and 2.5 m in height with concrete walls and ceiling. The three different environments correspond to different levels of multi-path conditions for evaluation.
Public Infrastructure Testbed: as shown in FIG. 5B, part of the experiments are also conducted using sensing links established between the devices of the subject invention and the existing AP devices publicly installed in an office (35×12 m²) and the lecture room. The inter-element spacing in the antenna array of public APs is empirically obtained with offline experiments.

The BeamSense is tested using the commodity devices listed as shown in FIG. 7, which include five 802.11ac/ax devices with beamformer capability, as well as an 802.11n router that supports ath9k CSI extraction tools for comparison with CSI-based algorithms. the antenna array is assembled with 2.7 cm inter-element separation and SMA interfaces are used to connect the RF frontend. Each Wi-Fi interface card is connected to a laptop that runs Linux 5.15, and all routers are configured to run openwrt with wired to the laptop. The laptop has 4 CPU cores running at 3.2 GHz. The devices are connected in a typical AP-STA setup using the userspace applications hostapd and wpa_supplicant, operating on the 5 GHz band for 802.11ac devices and the 2.4 GHz band for 802.11n/ax devices. To enable 802.11ac/ax beamforming, hostapd is launched with [SU-Beamformer], [SU-Beamformee], the highest [Sounding-Dimensions] and the largest possible bandwidth. It is observed that the frequency of the Wi-Fi chipset initiating channel sounding depends on the current network usage. Therefore, a pair of iPerf3 connections is run in the background to sustain a 1 MBps ambient traffic, which is also compliant with regular usage. The maximum achievable sounding frequency is around 30 Hz. For every single experiment, the BeamSense is evaluated with a pair of Wi-Fi devices from the same model, and they are placed in the designated locations with clear LOS.

### 7.2 Multi-Path Estimation Performance

In this section, the multi-path estimation performance is evaluated in the controlled testbed.

### Multi-Path Estimation Accuracy

To evaluate the accuracy of the BeamSense in estimating the multi-path profiles, the Wi-Fi transceivers are placed in multiple test locations and the BeamSense estimates the multi-path profile. A reflection path is manually set using a strong reflector, and focus is placed on the accuracy of estimating the parameters of LOS and reflection path. Because both transceivers and the reflector are static, the ground truth of parameters are obtained based on their actual locations.

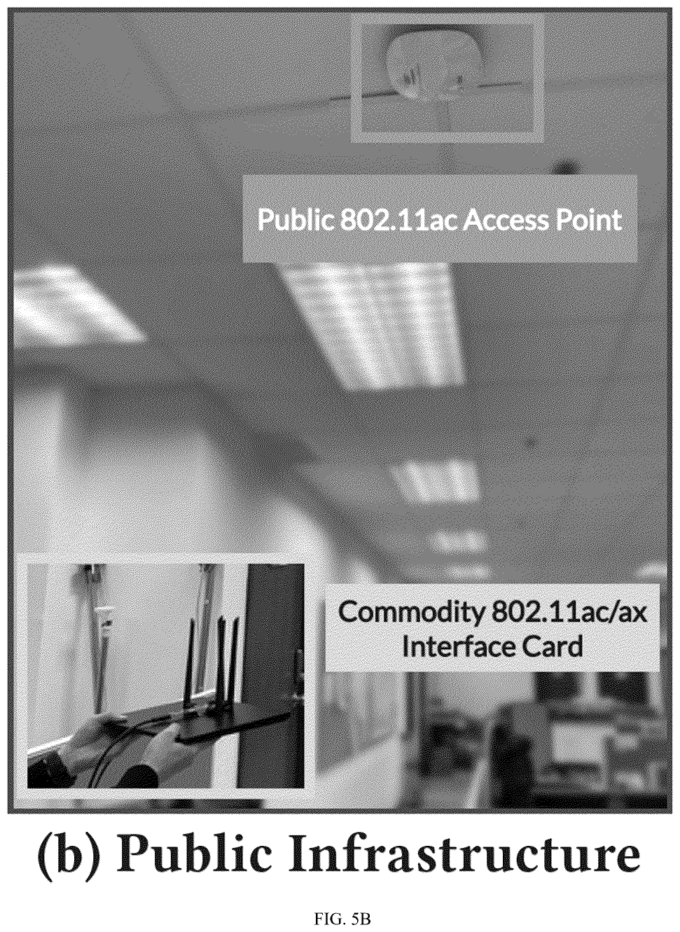

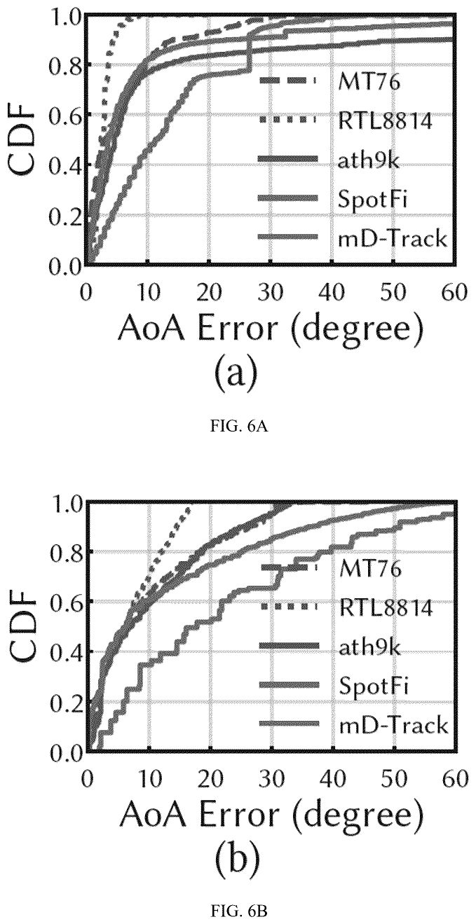

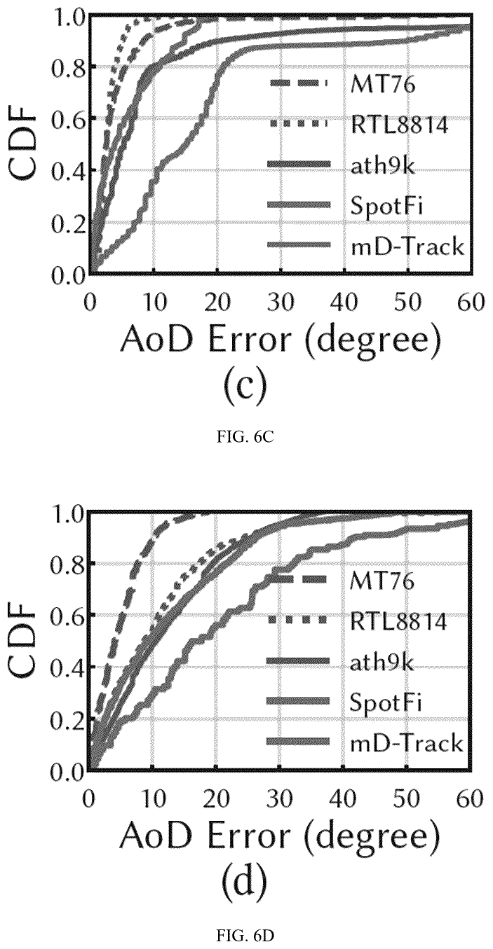

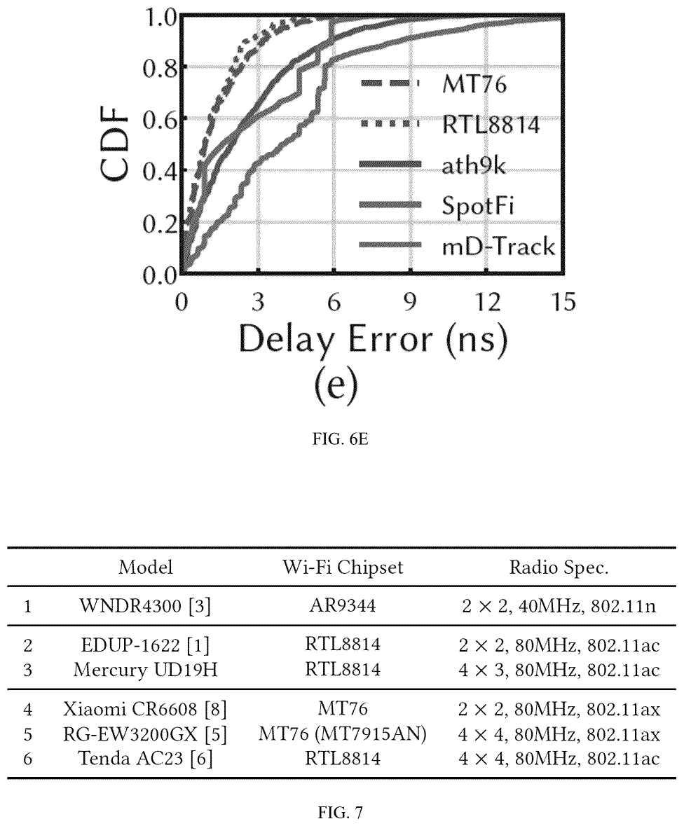

For comparison, two CSI-based multi-path estimators in the evaluations are employed as baselines:
mD-Track [53]: mD-Track is a state-of-the-art CSI-based multipath estimator which extracts the ToF, AoA, AoD, and Doppler from CSI.
SpotFi [28]: SpotFi uses the subspace-based 2D MUSIC algorithm to jointly estimate ToF and AoA from CSI.
Referring to FIGS. 6A-6E, the integrated results of the parameter estimation accuracy are shown.

With the same RF configuration, the accuracy of BeamSense is similar to that of the SOTA CSI-based estimator. The CSI measurements from ath9k are used to obtain the baseline of CSI-based estimators and bidirectional CBR generated from CSI is used to evaluate the performance of BeamSense under the same RF configuration. As shown, although CBR compresses information from CSI, BeamSense can still achieve median errors in estimating the angular parameters (AoA/AoD) of the LOS path within 5°, angular parameters of the reflection path within 8°, and relative delay between two paths within 2 ns. The results are similar to that of mD-Track with complete CSI, where the corresponding median errors are 3.68°, 7.72°, and 1.61 ns. Further, both BeamSense and mD-Track are more accurate than SpotFi in all experiments.

The overall performance of BeamSense in 802.11ac/ax devices outperforms CSI-based estimators using 802.11n devices, due to a larger bandwidth used. Using captured CBR from 802.11ac/ax devices RTL8814 and MT76, BeamSense can be more accurate than mDTrack with ath9k, where the median estimation errors are reduced to 2.67°, 6.28° and 0.91 ns, respectively. It is noted that Equation 12 is a joint optimization of attenuation, angular, and delay parameters. Therefore, the estimation accuracy for each individual parameter can benefit from the larger bandwidth used in 802.11ac/ax devices. One of the advantages provided by BeamSense is the compatibility with prevalent devices, demonstrating potential benefit for deployment of the existing sensing systems to these devices.

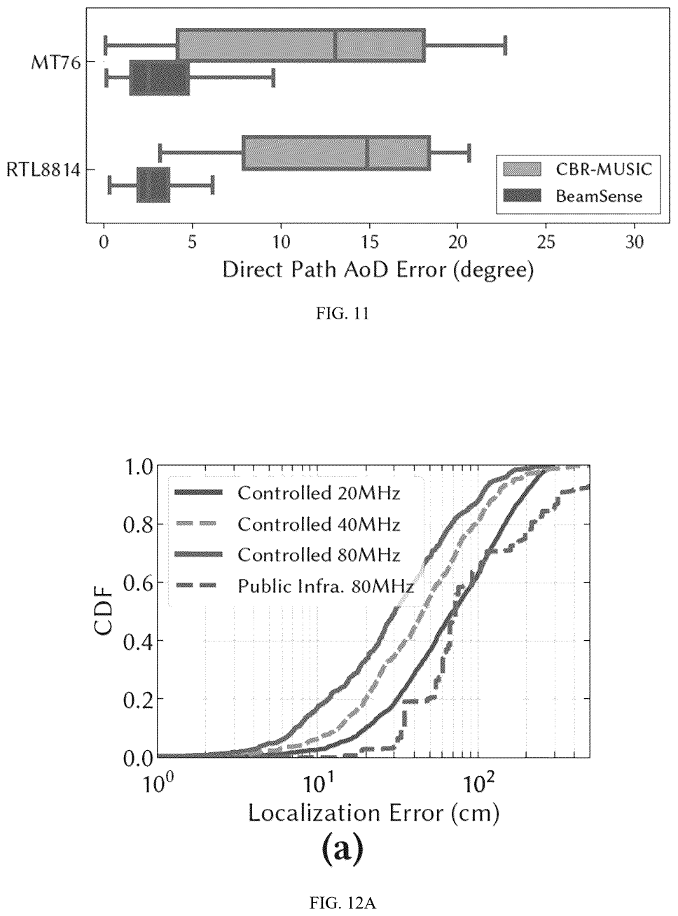

Next, performance of the BeamSense is compared with that of CBR-MUSIC, a sensing algorithm that estimates LOS AoD directly from CBR using MUSIC [22]. The MUSIC algorithm requires the knowledge of channel correlation matrix that cannot be derived from CBR. Therefore, CBR-MUSIC only approximates the central frequency correlation matrix by averaging all subcarriers' CBR. As shown in FIG. 11, this approximation yields large estimation errors, where the median AoD estimation errors of CBR-MUSIC are 4.17× and 4.86× which are higher than BeamSense for MT76 and RTL8814, respectively. The result demonstrates the significant advantage of BeamSense over directly estimating channel properties using the limited information of CBR.

### Path Matching

In most cases, the BeamSense and CSI-based estimator can obtain the same top-3 dominant paths. The extent to which BeamSense can enable the existing CSI-based algorithm to work on CBR by counting the matched paths between the results of mD-Track using raw CSI and CSI generated by BeamSense is investigated. Two paths are regarded as matched if the differences of all parameters are smaller than 5%. As shown in FIG. 10, in nearly all samples (99.2%), accurate LOS and reflection path parameters are obtained by BeamSense and mD-Track. In particular, in 78.2% of the total samples, BeamSense and mD-Track share the same top-3 dominant paths. The similarity drops distinctly after the fourth path. Because in many existing Wi-Fi sensing algorithms only the first several dominant components are considered [49], the results show that the BeamSense is capable to achieve a comparative performance for these tasks.

### Computational Overhead

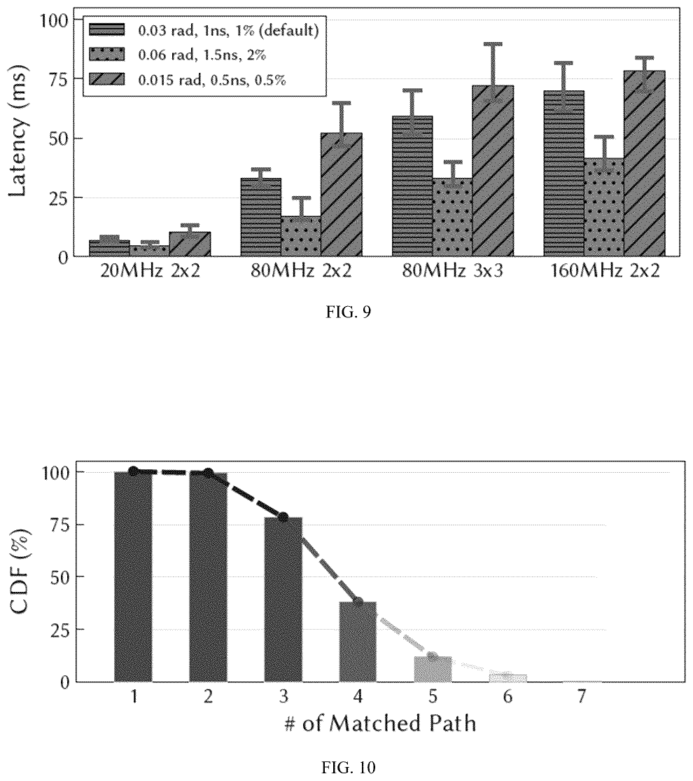

Even with high-dimensional RF configurations, the BeamSense could perform multi-path estimation within 80 ms. The complexity of multi-path estimation scales with the number of subcarriers, the dimension of MIMO, and the grid space setting. Thus, the end-to-end latency of BeamSense to a single multi-path profile from a pair of bidirectional CBR with different configurations is examined. FIG. 9 shows the integrated result. As expected, the time to perform multi-path estimation increases with the bandwidth, number of antennas, and grid space. Even so, the end-to-end latency of BeamSense with 234 subcarriers, 3×3 MIMO, and default grid setting is only 63 ms, which does not impose much load on applications with stringent real-time requirements.

### 7.3 Device Localization

### Evaluation Setup

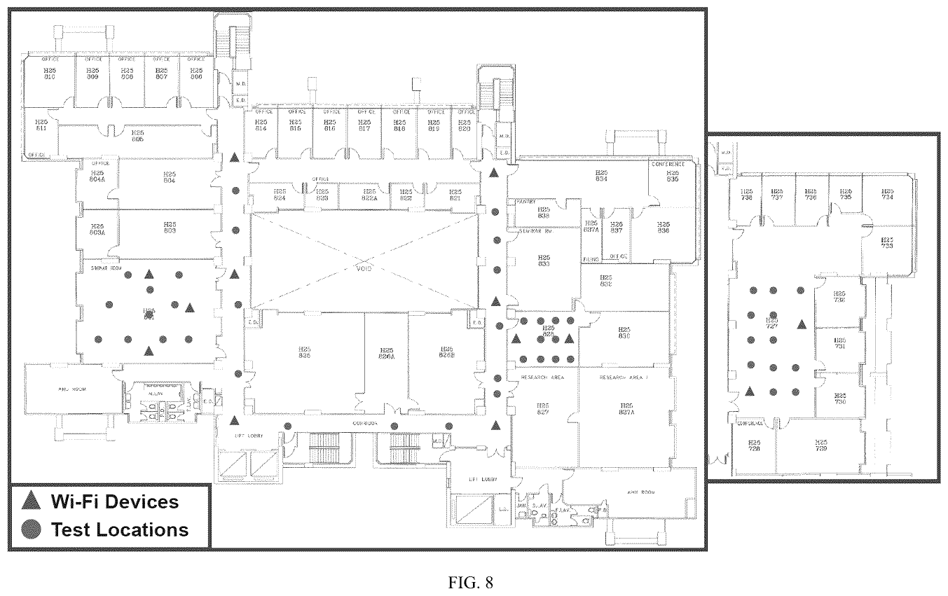

An application to localize connected devices with the multi-path estimations from the BeamSense is demonstrated. During the experiment, each user at the test location holds a Wi-Fi device paired with the AP device. Based on the estimated LOS parameters and the actual location of the AP device, the location of the user in the 2D plane is inferred. FIG. 8 depicts the test locations and AP locations in controlled and public testbeds. The same CSI-based methods stated in section 7.2 are used to estimate the multi-path parameters and build the localization application.

### Overall Performance

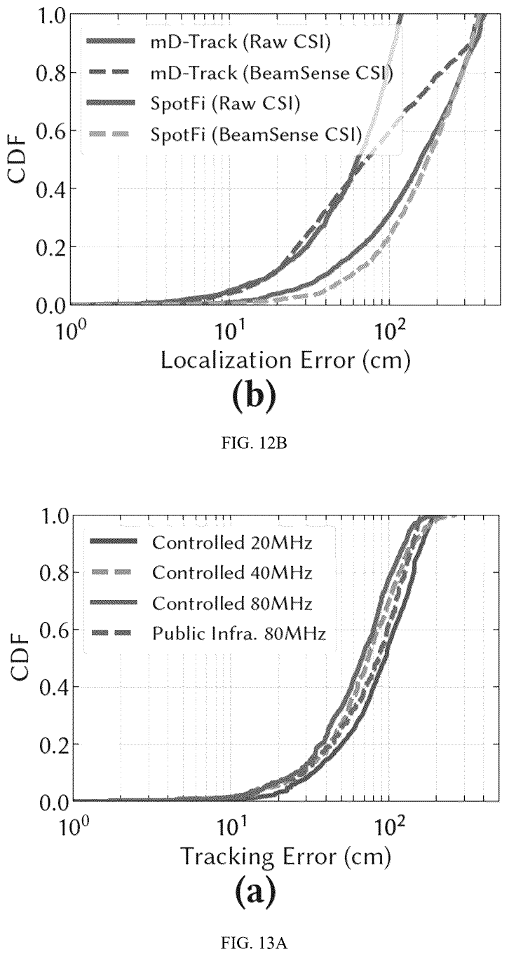

The BeamSense can achieve localization accuracy with 0.3˜0.7 m median error in the controlled testbed and 0.72 m median error in the public testbed. FIG. 12A shows the localization errors of BeamSense with different settings. In general, the precision increases with a larger bandwidth, where BeamSense is able to achieve a median error of 0.3 m, 0.45 m, and 0.7 m in the controlled testbed using 80 MHz, 40 MHz, and 20 MHz bandwidth, respectively. However, as it is difficult to obtain the accurate antenna pattern of public devices, the median error with public infrastructure using 80 MHz bandwidth increases by 140% (0.72 m).

CSI-based methods can achieve a similar performance between using original CSI and the BeamSense CSI. The estimation of BeamSense inevitably contains inaccuracies. To study how it affects the downstream applications, the localization error of CSI-based methods using original CSI and BeamSense CSI estimated from CBR on ath9k are compared. FIG. 12B shows the localization error with two different sources. As seen, the median localization errors of mD-Track using raw CSI and BeamSense CSI are 0.63 m and 0.72 m, where the difference is within 10 cm. SpotFi using raw CSI achieves a median error of 1.57 m, while the median error using BeamSense CSI is 1.75 m, where the difference is around 10%. Albeit BeamSense CSI diffuses the estimation errors, a similar performance is achieved.

### 7.4 Passive Tracking

### Evaluation Setup

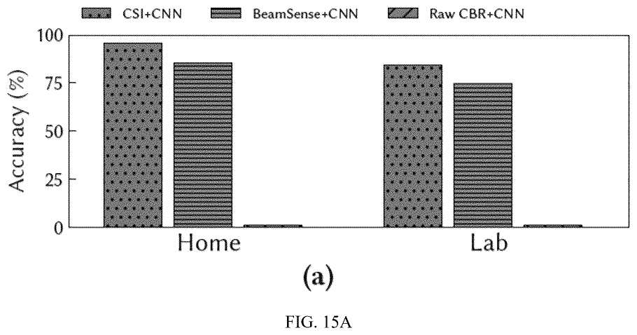

An application to passively track the trajectory of the user near the sensing link is demonstrated. This application captures path profiles with similar Doppler characteristics and estimates a trajectory using optimization methods introduced in [37]. The same apparatus stated in section 7.3 is used and a user is asked to walk near the sensing link following designated trajectories. An example trajectory is shown in FIG. 14. A user walks following a rectangle, and dots show the BeamSense estimated user positions over time, based on which the trajectory of the user is estimated.

### Overall Performance

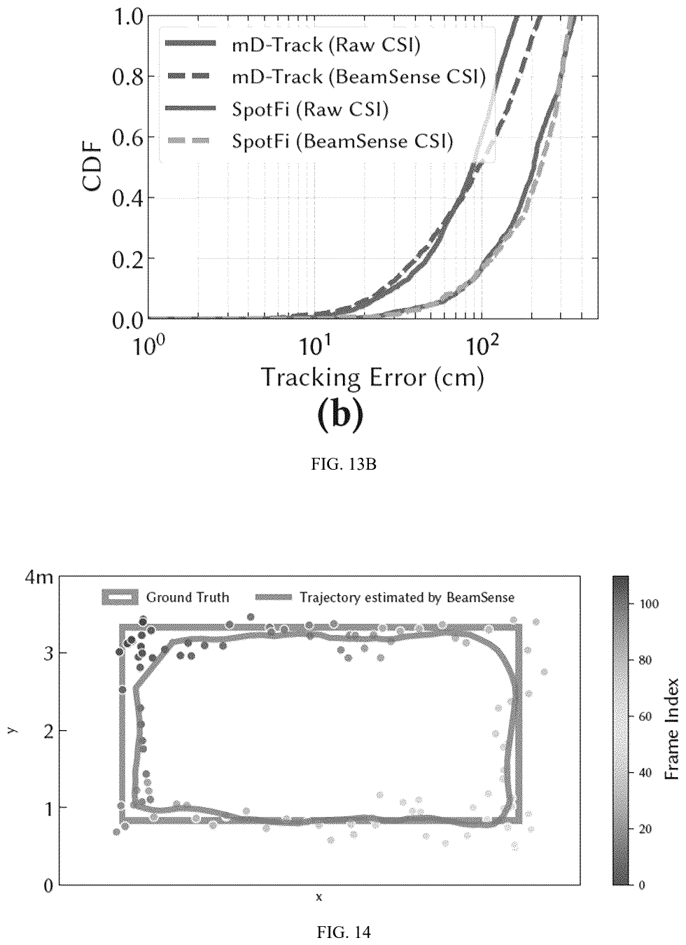

The BeamSense achieves a median error of 0.67˜0.95 m across different settings. As shown in FIG. 13A, in both controlled and public testbeds, the BeamSense achieves a stable performance with median errors ranging from 0.67 m to 0.95 m. With the bandwidth increase from 20 MHz to 40 MHz, a significant improvement (21.97%) in tracking accuracy is observed, but this improvement from 40 MHz to 80 MHz is decreased (8.7%). While the higher bandwidth enables more accurate delay estimates, the tracking errors are dominated by the angle estimation error after increasing to a certain bandwidth. the same experiment is conducted as described in section 7.3 to evaluate the CSI based methods with BeamSense CSI, where FIG. 13B shows results similar to the results of the previous discussions.

### 7.5 Sign Language Recognition

### Evaluation Setup

A sign language recognition application using CSI estimated by the BeamSense is demonstrated. The experiments involve 3 users, and each user is asked to stand nearby the sensing link to perform 20 different sign words. Each sign word is repeated 10 times and elapses 1˜2 seconds. A pair of RTL8814 interface cards is used to report CBR during this period. In total, 600 segmented bidirectional CBR series are collected for testing.

A simple 9-layer Convolution Neural Network (CNN) is built for classification. To examine the cross-domain performance, three different types of training/testing datasets are considered. The first type of dataset uses samples from the same user for both training and testing. The second type follows a cross-subject manner, where samples from two of the three users are used for training, and samples from the other user are used for testing. The third type mixes all data samples of three users. Across all configurations, the ratio between training and testing samples is 3:1.

### Overall Performance

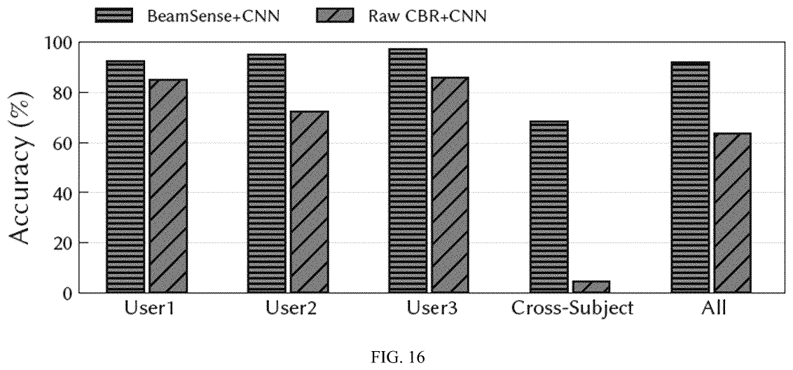

FIG. 16 shows the integrated recognition accuracy of the CNN classifier with the BeamSense estimated channel states. For comparison, another CNN classifier is built with the same network architecture while using raw CBR frames only.

CNN classifier with BeamSense estimated channel state achieves 92.5˜97.14% accuracy with in-subject samples. As shown, for datasets comprising samples from each individual user, the CNN classifier with BeamSense estimated CSI can achieve 92.5%, 95%, and 97.14% accuracy, respectively, compared with 85%, 72.5%, and 85.71% for CNN with raw CBR. Compared to directly using CBR frames, Beam-Sense could improve the accuracy by 17.51% on average, which demonstrates that the primitive features extracted by the BeamSense are more effectively depicting human activities.

The BeamSense achieves around 70% recognition accuracy in cross-subject samples, which vastly improves the cross-domain capability of sensing with CBR. For the dataset comprising cross-subject samples, the CNN classifier with raw CBR only achieves 4.49% accuracy, which is similar to the results of random guessing. This is because the same gesture performed by different people typically can produce different channel decomposition results. As a result, the ML model rarely learns cross-domain knowledge from CBR frames. On the other hand, the CNN classifier underpinned by the BeamSense can achieve an accuracy of 70%. This is because the BeamSense can accurately reconstruct the multi-path channel from CBR, making it more robust across different deployment environments and use scenarios. It is also corroborated in the mixed dataset, where Beam-Sense (92.17%) improves the accuracy by 45.1% as of using raw CBR (63.48%).

### Performance on SignFi Dataset

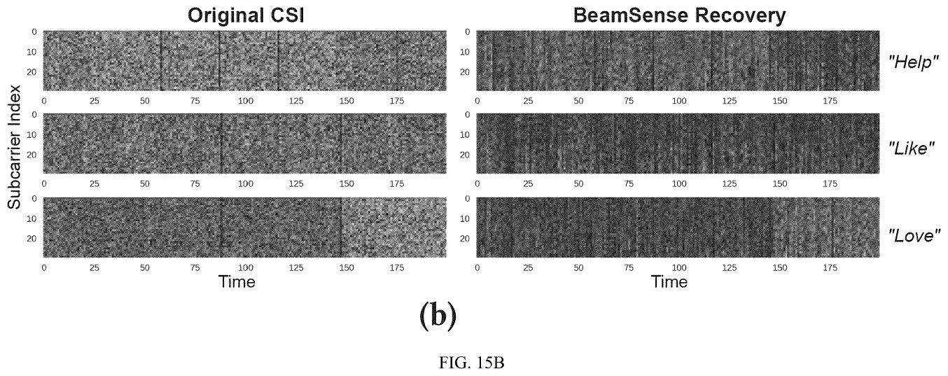

The classification performance on the SignFi dataset is also examined. The dataset comprises 15,780 samples of CSI series for recognizing 276 sign languages, captured in 2 different environments. Bidirectional CBR from each CSI frame is generated and the identical CNN classifier is configured to evaluate the accuracy with raw CSI, raw CBR, and the BeamSense estimated CSI. FIG. 15A shows the integrated results.

Raw CBR is ill-suited for this task with a large number of classes, while the BeamSense can still achieve an average accuracy of 80.09%, which only drops around 10% compared to using original CSI. As seen, for both environments, the performance of using raw CBR drops severely due to the increased number of output classes. On the other hand, using the information extracted by BeamSense can achieve a performance of 85.27% and 74.91%, which only drops around 10% from using the original CSI (95.64% and 84.64%). This result demonstrates BeamSense enables sensing with CBR even for tasks with increased difficulty.

FIG. 15B shows an example of BeamSense recovered CSI series representing three sign words, ‘Help’, ‘Like’, and ‘Love’. Each (time, subcarrier) pixel in the RF image is rendered based on the normalized RX gains of three antennas on the AP device (that is, mapping to three RGB channels). Similar to image recognition methods, the CNN classifier learns different gestures by recognizing the low-level features of the RF image, for example, blockage patterns (the occasional dark lines in the figure), colors, and duration of each segment. As shown in FIG. 15B, the RF images generated by BeamSense exhibit similar patterns to that of the original CSI. Specifically, the cosine similarity between the datasets of BeamSense-CSI and the original CSI is 0.832. This demonstrates why BeamSense-underpinned CNN is able to achieve a similar performance to that of CNN operated on the original CSI.

### 8 Discussion

### Number of TX/RX Antennas

In certain Wi-Fi router deployments, the device may use more antennas in reception (for example, 4) while using fewer antennas in transmission (for example, 3) for intensifying the uplink performance. Under this circumstance, the intrinsic fingerprints of downlink and uplink channels are identical and thus the fingerprint test matrix cannot be constructed. Therefore, as a requirement of the BeamSense, each device should use the number of antennas in both transmission and reception, which is configurable on most Wi-Fi devices via the mac80211 interface.

### Handling Absence of Beamformer Capability

The BeamSense leverages bidirectional CBR to estimate the multi-path channel. Although the STA beamformee capability is widely present, the STA beamformer capability is rare. In the city-scale measurement, only 1.0% STAs report beamformer capability. To collect bidirectional CBR in this case, a simple workaround is to inject NDPA and NDP frames via packet injection and emulation [14] from STA to trigger uplink channel sounding.

### Privacy Concerns

Sniffing on-the-air CBR frames may raise privacy concerns and even disclose the critical physical features of the channel. To resolve this issue, an effective solution is to enforce WPA3 [7] in the connection, which will encrypt all management frames including the CBR between two WiFi devices. In such cases, only authorized devices that hold the encryption key can decrypt the CBR from wireless traffic. However, this would not affect the applicability of the system, because legitimate users usually associate with the target AP.

The generalized Wi-Fi sensing paradigm based on compressed beamforming reports (CBR) is provided. A framework that is computationally efficient to map CBR to a multi-path profile is designed. The wireless sensing system of the subject invention is implemented on several prevalent models of Wi-Fi devices and the performance of the wireless sensing system is evaluated with microbenchmarks and three representative Wi-Fi sensing applications. the results show that the wireless sensing system can achieve high sensing accuracy and superior generalizability.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### EXEMPLARY EMBODIMENTS

Embodiment 1. A wireless sensing method based on compressed beamforming reports (CBR), comprising:
performing channel sounding and transmit (TX) beamforming;
performing sniffing or extracting information from Wi-Fi traffic; and
performing multi-path estimation.

Embodiment 2. The method of embodiment 1, wherein the performing channel sounding comprises evaluating a control frame Null Data Packet Announcement (NDPA) from a beamformer station (STA) and selecting another STA as the beamformee to receive subsequent Null Data Packet (NDP) frame.

Embodiment 3. The method of embodiment 2, wherein the NDP is a sounding packet that only includes a standalone frame preamble.

Embodiment 4. The method of embodiment 2, wherein the performing channel sounding further comprises performing channel state information (CSI) measurement to analyze ubiquity of CSI.

Embodiment 5. The method of embodiment 4, wherein the performing CSI measurement comprises extracting Wi-Fi chipset information by a public device tree and chipset specifications.

Embodiment 6. The method of embodiment 5, wherein the performing CSI measurement further comprises a two-step filtering process to analyze collected packet traces to exclude devices that do not meet conditions to install any existing CSI extraction tools.

Embodiment 7. The method of embodiment 6, wherein the two-step filtering process comprises a first step of vendor-based filtering and a second step of radio capability-based filtering.

Embodiment 8. The method of embodiment 4, wherein the performing channel sounding further comprises computing beamforming parameters.

Embodiment 9. The method of embodiment 8, wherein the performing channel sounding further comprises generating compressed Beamforming Report for analyzing transmit (TX) beamforming support among deployed Wi-Fi devices.

Embodiment 10. The method of embodiment 9, wherein the generating compressed Beamforming Report comprises computing steering matrices and computing averaged SNR (ASNR).

Embodiment 11. The method of embodiment 4, wherein the performing channel sounding further comprises generating, by the beamformee, beamforming reports, and sending the reports back to the beamformer, upon measuring the channel state information from the NDP.

Embodiment 12. The method of embodiment 1, wherein the performing sniffing information from Wi-Fi traffic comprises sniffing ambient traffic to collect CBR frames of adjacent Wi-Fi links.

Embodiment 13. The method of embodiment 1, wherein the performing extracting information from Wi-Fi traffic comprises extracting CBR frames from a local Wi-Fi interface working in a promiscuous mode.

Embodiment 14. The method of embodiment 1, wherein the performing multi-path estimation comprises performing multi-path modeling with CBR to analyze relationship between signal propagation characteristics and information in CBR by modeling a multi-path channel based on uplink and downlink steering matrices.

Embodiment 15. The method of embodiment 14, wherein the performing multi-path modeling with CBR comprises performing multi-path modeling with CBR from physical paths to channel state information (CSI) and subsequently from CSI to CBR.

Embodiment 16. The method of embodiment 14, wherein the performing multi-path estimation further comprises performing maximum likelihood multi-path estimation.

Embodiment 17. The method of embodiment 16, wherein the performing maximum likelihood multi-path estimation comprises analyzing multi-path fingerprint in CBR, performing fingerprint matching, and performing maximum-likelihood estimation (MLE)-based multi-path reconstruction.

Embodiment 18. The method of embodiment 1, wherein the performing multi-path estimation is optimized by iterative searching.

Embodiment 19. The method of embodiment 1. wherein the performing multi-path estimation is optimized by seeded initialization.

Embodiment 20. The method of embodiment 1. further comprising outputting results of the multi-path estimation for wireless sensing applications.

### REFERENCES

[1] EDUP-1622 802.11ac Dual Band WIFI USB 3.0 Adapter. https://www.szedup.com/product-item/802-11ac-dual-band-wifi-usb-3-0-adapter.
[2] Linux Wireless: ath9k Products. https://wireless.wiki.kernel.org/en/users/drivers/ath9k/products.
[3] Netgear WNDR4300 v1. https://openwrt.org/toh/netgear/wndr4300.
[4] OpenWrt Wiki—Supported devices. https://openwrt.org/supported_devices.
[5] Ruijie X32 Pro. https://www.ruijienetworks.com/products/REYEEMeshWi-Fi/RG-EW1200-Series/RG-EW3200GX-PRO.
[6] Tenda AC2100 Dual Band Gigabit WiFi Router. https://www.tendacn.com/product/AC23.html.
[7] WPA3 Specification. https://www.wi-fi.org/file/wpa3-specification.
[8] Xiaomi Mi Router CR6608. https://openwrt.org/toh/hwdata/xiaomi/xiaomi_mi_router_cr6608.
[9] IEEE Standard for Information technology—Telecommunications and Information Exchange between Systems—Local and Metropolitan Area Networks—Specific requirements—Part 11: Wireless LAN Medium Access Control (MAC) and Physical Layer (PHY) Specifications—Amendment 4: Enhancements for Very High Throughput for Operation in Bands below 6 GHz. IEEE Std 802.11ac(TM)-2013, pages 1-425, Dec 2013.
[10] Fadel Adib and Dina Katabi. See through Walls with WiFi! In Proceedings of the ACM SIGCOMM 2013 Conference on SIGCOMM, SIGCOMM '13, page 75-86, New York, NY, USA, 2013. Association for Computing Machinery.
[11] P. Bahl and V.N. Padmanabhan. RADAR: An In-building RF-based User Location and Tracking System. In Proceedings IEEE INFOCOM 2000. Conference on Computer Communications. Nineteenth Annual Joint Conference of the IEEE Computer and Communications Societies (Cat. No.00CH37064), volume 2, pages 775-784 vol.2, 2000.
[12] Arjun Bakshi, Yifan Mao, Kannan Srinivasan, and Srinivasan Parthasarathy. Fast and Efficient Cross Band Channel Prediction Using Machine Learning. In The 25th Annual International Conference on Mobile Computing and Networking, MobiCom '19, New York, NY, USA, 2019. Association for Computing Machinery.
[13] D. I. Cartwright and M. J. Field. A Refinement of the Arithmetic Mean-Geometric Mean Inequality. Proceedings of the American Mathematical Society, 71(1):36-38, 1978.
[14] Ruirong Chen and Wei Gao. TransFi: Emulating Custom Wireless Physical Layer from Commodity Wifi. In Proceedings of the 20th Annual International Conference on Mobile Systems, Applications and Services, MobiSys '22, page 357-370, New York, NY, USA, 2022. Association for Computing Machinery.
[15] Zhe Chen, Guorong Zhu, Sulei Wang, Yuedong Xu, Jie Xiong, Jin Zhao, Jun Luo, and Xin Wang. M3: Multipath Assisted Wi-Fi Localization with a Single Access Point. IEEE Transactions on Mobile Computing, 20(2):588-602, 2021.
[16] Rui Du, Hailiang Xie, Mengshi Hu, Yan Xin, Stephen McCann, Michael Montemurro, Tony Xiao Han, Jie Xu, et al. An Overview on IEEE 802.11 bf: WLAN Sensing. arXiv preprint arXiv:2207.04859, 2022.
[17] DeviWiki (ex WikiDevi). List of Wi-Fi Device IDs in Linux, Oct 2016. https://deviwiki.com/wiki/List_of_Wi-Fi_Device_IDs_in_Linux.
[18] Chuhan Gao, Yilong Li, and Xinyu Zhang. LiveTag: Sensing Human-Object Interaction through Passive Chipless WiFi Tags. In 15th USENIX Symposium on Networked Systems Design and Implementation, NSDI '18, pages 533-546, Renton, WA, April 2018. USENIX Association.
[19] Francesco Gringoli, Matthias Schulz, Jakob Link, and Matthias Hollick. Free Your CSI: A Channel State Information Extraction Platform For Modern Wi-Fi Chipsets. In Proceedings of the 13th International Workshop on Wireless Network Testbeds, Experimental Evaluation and Characterization, WiNTECH '19, page 21-28, New York, NY, USA, 2019. Association for Computing Machinery.
[20] Daniel Halperin, Wenjun Hu, Anmol Sheth, and David Wetherall. Tool Release: Gathering 802.11n Traces with Channel State Information. SIGCOMM Comput. Commun. Rev., 41(1):53, jan 2011.
[21] Yi Hong. Delay-Doppler Communications: Principles and applications. Elsevier Science and Technology, 2022.
[22] Sohei Itahara, Sota Kondo, Kota Yamashita, Takayuki Nishio, Koji Yamamoto, and Yusuke Koda. Beamforming Feedback-Based Model-Driven Angle of Departure Estimation Toward Legacy Support in WiFi Sensing: An Experimental Study. IEEE Access, 10:59737-59747, 2022.
[23] Woojae Jeong, Jinhwan Jung, Yuanda Wang, Shuai Wang, Seokwon Yang, Qiben Yan, Yung Yi, and Song Min Kim. SDR Receiver Using Commodity WiFi via Physical-Layer Signal Reconstruction. In Proceedings of the 26th Annual International Conference on Mobile Computing and Networking, MobiCom '20, New York, NY, USA, 2020. Association for Computing Machinery.
[24] Takamochi Kanda, Takashi Sato, Hiromitsu Awano, Sota Kondo, and Koji Yamamoto. Respiratory Rate Estimation Based on WiFi Frame Capture. In 2022 IEEE 19th Annual Consumer Communications & Networking Conference (CCNC), pages 881-884. IEEE, 2022.
[25] Sorachi Kato, Takuma Matsukawa, Tomoki Murakami, Takuya Fujihashi, Takashi Watanabe, and Shunsuke Saruwatari. Fundamental Investigation of Wi-Fi Beamforming Report Properties on Wireless Sensing. In 2022 IEEE 12th Sensor Array and Multichannel Signal Processing Workshop (SAM), pages 341-344. IEEE, 2022.
[26] Sorachi Kato, Tomoki Murakami, Takuya Fujihashi, TakashiWatanabe, and Shunsuke Saruwatari. CBR-ACE: Counting Human Exercise Using Wi-Fi Beamforming Reports. Journal of Information Processing, 30:66-74, 2022.
[27] Sota Kondo, Sohei Itahara, Kota Yamashita, Koji Yamamoto, Yusuke Koda, Takayuki Nishio, and Akihito Taya. Bi-directional Beamforming Feedback-based Firmware-agnostic WiFi sensing: An Empirical Study. IEEE Access, 10:36924-36934, 2022.
[28] Manikanta Kotaru, Kiran Joshi, Dinesh Bharadia, and Sachin Katti. SpotFi: Decimeter Level Localization Using WiFi. In Proceedings of the 2015 ACM Conference on Special Interest Group on Data Communication, SIGCOMM '15, page 269-282, New York, NY, USA, 2015. Association for Computing Machinery.
[29] Yuanjie Li, Qianru Li, Zhehui Zhang, Ghufran Baig, Lili Qiu, and Songwu Lu. Beyond 5G: Reliable Extreme Mobility Management. In Proceedings of the Annual Conference of the ACM Special Interest Group on Data Communication on the Applications, Technologies, Architectures, and Protocols for Computer Communication, SIGCOMM '20, page 344-358, New York, NY, USA, 2020. Association for Computing Machinery.
[30] Zhuqi Li, Yaxiong Xie, Longfei Shangguan, Rotman Ivan Zelaya, Jeremy Gummeson, Wenjun Hu, and Kyle Jamieson. Towards Programming the Radio Environment with Large Arrays of Inexpensive Antennas. In 16th USENIX Symposium on Networked Systems Design and Implementation, NSDI '19, pages 285-300, Boston, MA, February 2019. USENIX Association.
[31] Scapy Library. https://scapy.net/.
[32] Yongsen Ma, Gang Zhou, and Shuangquan Wang. WiFi Sensing with Channel State Information: A Survey. ACM Comput. Surv., 52(3), jun 2019.
[33] Yongsen Ma, Gang Zhou, Shuangquan Wang, Hongyang Zhao, and Woosub Jung. SignFi: Sign Language Recognition Using WiFi. Proc. ACM Interact. Mob. Wearable Ubiquitous Technol., 2(1), mar 2018.
[34] Francesca Meneghello, Michele Rossi, and Francesco Restuccia. DeepCSI: Rethinking Wi-Fi Radio Fingerprinting Through MU-MIMO CSI Feedback Deep Learning. In 2022 IEEE 42nd International Conference on Distributed Computing Systems, ICDCS '22. IEEE, jul 2022.
[35] Kazuki Noguchi, Osamu Muta, Tomoki Murakami, and Shinya Otsuki. A CSIbased Object Detection Scheme using Interleaved Subcarrier Selection in Wireless LAN Systems with Distributed Antennas. In 2021 IEEE 94th Vehicular Technology Conference (VTC2021-Fall), pages 01-05, Sep. 2021.
[36] Kun Qian, Chenshu Wu, Zheng Yang, Yunhao Liu, and Kyle Jamieson. Widar: Decimeter-level Passive Tracking Via Velocity Monitoring with Commodity Wi-Fi. In Proceedings of the 18th ACM International Symposium on Mobile Ad Hoc Networking and Computing, MobiHoc '17, pages 1-10, 2017.
[37] Kun Qian, Chenshu Wu, Yi Zhang, Guidong Zhang, Zheng Yang, and Yunhao Liu. Widar2.0: Passive Human Tracking with A Single Wi-Fi Link. In Proceedings of the 16th Annual International Conference on Mobile Systems, Applications, and Services, MobiSys' 18, pages 350-361, 2018.
[38] R. Schmidt. Multiple Emitter Location and Signal Parameter Estimation. IEEE Transactions on Antennas and Propagation, 34(3):276-280, 1986.
[39] Ken Shoemake. Animating Rotation with Quaternion Curves. SIGGRAPH Comput. Graph., 19(3):245-254, jul 1985.
[40] Sanjib Sur, Xinyu Zhang, Parmesh Ramanathan, and Ranveer Chandra. BeamSpy: Enabling Robust 60 GHz Links Under Blockage. In 13th USENIX Symposium on Networked Systems Design and Implementation, NSDI '16, pages 193-206, 2016.
[41] Navod Suraweera, Alycia Winter, Julian Sorensen, Mark Johnson, Shenghong Li, Iain B. Collings, Stephen V. Hanly, Wei Ni, and Mark Hedley. Stand-off Detection of Human Presence and Movement Using IEEE 802.11ac Beamforming Reports. In 2019 13th International Conference on Signal Processing and Communication Systems (ICSPCS), pages 1-7, 2019.
[42] Navod Suraweera, Alycia Winter, Julian Sorensen, Shenghong Li, Mark Johnson, Iain B. Collings, Stephen V. Hanly, Wei Ni, and Mark Hedley. Passive Through-Wall Counting of PeopleWalking Using WiFi Beamforming Reports. IEEE Systems Journal, 15(4):5476-5482, 2021.
[43] Sheng Tan, Yili Ren, Jie Yang, and Yingying Chen. Commodity WiFi Sensing in Ten Years: Status, Challenges, and Opportunities. IEEE Internet of Things Journal, 9(18):17832-17843, 2022.
[44] David Tse and Pramod Viswanath. Fundamentals of Wireless Communication. Cambridge University Press, USA, 2005.
[45] Deepak Vasisht, Swarun Kumar, and Dina Katabi. Decimeter-Level Localization with a Single WiFi Access Point. In 13th USENIX Symposium on Networked Systems Design and Implementation, NSDI '16, pages 165-178, Santa Clara, CA, March 2016. USENIX Association.
[46] Deepak Vasisht, Swarun Kumar, Hariharan Rahul, and Dina Katabi. Eliminating Channel Feedback in Next-Generation Cellular Networks. In Proceedings of the 2016 ACM SIGCOMM Conference, SIGCOMM '16, page 398-411, New York, NY, USA, 2016. Association for Computing Machinery.
[47] Ju Wang, Hongbo Jiang, Jie Xiong, Kyle Jamieson, Xiaojiang Chen, Dingyi Fang, and Binbin Xie. LiFS: Low Human-effort, Device-free Localization with Finegrained Subcarrier Information. In Proceedings of the 22nd Annual International Conference on Mobile Computing and Networking, MobiCom '16, pages 243-256, 2016.
[48] SongWang, Jingqi Huang, and Xinyu Zhang. Demystifying Millimeter-Wave V2X: Towards Robust and Efficient Directional Connectivity under High Mobility. In Proceedings of the 26th Annual International Conference on Mobile Computing and Networking, MobiCom '20, New York, NY, USA, 2020. Association for Computing Machinery.
[49] Wei Wang, Alex X. Liu, Muhammad Shahzad, Kang Ling, and Sanglu Lu. Understanding and Modeling of WiFi Signal Based Human Activity Recognition. In Proceedings of the 21st Annual International Conference on Mobile Computing and Networking, MobiCom '15, page 65-76, New York, NY, USA, 2015. Association for Computing Machinery.
[50] Stephen J. Wright. Coordinate Descent Algorithms. Math. Program., 151(1):3-34, jun 2015.
[51] Wei Xi, Chen Qian, Jinsong Han, Kun Zhao, Sheng Zhong, Xiang-Yang Li, and Jizhong Zhao. Instant and Robust Authentication and Key Agreement among Mobile Devices. In Proceedings of the 2016 ACM SIGSAC Conference on Computer and Communications Security, CCS '16, page 616-627, New York, NY, USA, 2016. Association for Computing Machinery.
[52] Yaxiong Xie, Zhenjiang Li, and Mo Li. Precise Power Delay Profiling with Commodity WiFi. In Proceedings of the 21st Annual International Conference on Mobile Computing and Networking, MobiCom '15, page 53-64, New York, NY, USA, 2015. ACM.
[53] Yaxiong Xie, Jie Xiong, Mo Li, and Kyle Jamieson. MD-Track: Leveraging Multi-Dimensionality for Passive Indoor Wi-Fi Tracking. In The 25th Annual International Conference on Mobile Computing and Networking, MobiCom '19, New York, NY, USA, 2019. Association for Computing Machinery.
[54] Zheng Yang, Zimu Zhou, and Yunhao Liu. From RSSI to CSI: Indoor Localization via Channel Response. ACM Comput. Surv., 46(2), dec 2013.
[55] Moustafa Youssef and Ashok Agrawala. The Horus WLAN Location Determination System. In Proceedings of the 3rd International Conference on Mobile Systems, Applications, and Services, MobiSys '05, page 205-218, New York, NY, USA, 2005. Association for Computing Machinery.
[56] Youwei Zeng, Dan Wu, Jie Xiong, Enze Yi, Ruiyang Gao, and Daqing Zhang. FarSense: Pushing the Range Limit of WiFi-Based Respiration Sensing with CSI Ratio of Two Antennas. Proc. ACM Interact. Mob. Wearable Ubiquitous Technol., 3(3), sep 2019.
[57] Yunze Zeng, Parth H. Pathak, and Prasant Mohapatra. WiWho: WiFi-Based Person Identification in Smart Spaces. In 2016 15th ACM/IEEE International Conference on Information Processing in Sensor Networks, IPSN '16, pages 1-12, 2016.
[58] Yue Zheng, Yi Zhang, Kun Qian, Guidong Zhang, Yunhao Liu, Chenshu Wu, and Zheng Yang. Zero-Effort Cross-Domain Gesture Recognition with Wi-Fi. In Proceedings of the 17th Annual International Conference on Mobile Systems, Applications, and Services, MobiSys '19, page 313-325, New York, NY, USA, 2019. Association for Computing Machinery.

We claim:

1. A wireless sensing method based on compressed beamforming reports (CBR), comprising:
performing channel sounding and transmit (TX) beamforming;
performing sniffing or extracting information from Wi-Fi traffic; and
performing multi-path estimation.

2. The method of claim 1, wherein the performing channel sounding comprises evaluating a control frame Null Data Packet Announcement (NDPA) from a beamformer station (STA) and selecting another STA as the beamformee to receive subsequent Null Data Packet (NDP) frame.

3. The method of claim 2, wherein the NDP is a sounding packet that only includes a standalone frame preamble.

4. The method of claim 2, wherein the performing channel sounding further comprises performing channel state information (CSI) measurement to analyze ubiquity of CSI.

5. The method of claim 4, wherein the performing CSI measurement comprises extracting Wi-Fi chipset information by a public device tree and chipset specifications.

6. The method of claim 5, wherein the performing CSI measurement further comprises a two-step filtering process to analyze collected packet traces to exclude devices that do not meet conditions to install any existing CSI extraction tools.

7. The method of claim 6, wherein the two-step filtering process comprises a first step of vendor-based filtering and a second step of radio capability-based filtering.

8. The method of claim 4, wherein the performing channel sounding further comprises computing beamforming parameters.

9. The method of claim 8, wherein the performing channel sounding further comprises generating compressed Beamforming Report for analyzing transmit (TX) beamforming support among deployed Wi-Fi devices.

10. The method of claim 9, wherein the generating compressed Beamforming Report comprises computing steering matrices and computing averaged SNR (ASNR).

11. The method of claim 4, wherein the performing channel sounding further comprises generating, by the beamformee, beamforming reports, and sending the reports back to the beamformer, upon measuring the channel state information from the NDP.

12. The method of claim 1, wherein the performing sniffing information from Wi-Fi traffic comprises sniffing ambient traffic to collect CBR frames of adjacent Wi-Fi links.

13. The method of claim 1, wherein the performing extracting information from Wi-Fi traffic comprises extracting CBR frames from a local Wi-Fi interface working in a promiscuous mode.

14. The method of claim 1, wherein the performing multi-path estimation comprises performing multi-path modeling with CBR to analyze relationship between signal propagation characteristics and information in CBR by modeling a multi-path channel based on uplink and downlink steering matrices.

15. The method of claim 14, wherein the performing multi-path modeling with CBR comprises performing multi-path modeling with CBR from physical paths to channel state information (CSI) and subsequently from CSI to CBR.

16. The method of claim 14, wherein the performing multi-path estimation further comprises performing maximum likelihood multi-path estimation.

17. The method of claim 16, wherein the performing maximum likelihood multi-path estimation comprises analyzing multi-path fingerprint in CBR, performing fingerprint matching, and performing maximum-likelihood estimation (MLE)-based multi-path reconstruction.

18. The method of claim 1, wherein the performing multi-path estimation is optimized by iterative searching.

19. The method of claim 1, wherein the performing multi-path estimation is optimized by seeded initialization.

20. The method of claim 1, further comprising outputting results of the multi-path estimation for wireless sensing applications.
